(19) United States
(12) Patent Application Publication
(10) Pub. No.: US 2005/0168595 A1
(43) Pub. Date: Aug. 4, 2005

(54) System and method to enhance the quality of digital images

(76) Inventor: Michael F. White, New Braunfels, TX (US)

Correspondence Address: Koestner Bertani, LLP, Post Office Box 26780, Austin, TX, 78755, US

(21) Appl. No.: 10/929,962

(22) Filed: Aug. 30, 2004

Related U.S. Application Data
(60) Provisional application No. 60/541,682, filed on Feb. 4, 2004.

(51) Int. Cl. H04N 5/228

(52) U.S. Cl. 348/222.1

(57) ABSTRACT

The present invention provides numerous automated processes with which to enhance the quality of digital images. The process may be easily and intuitively chosen based on the type or genre of digital image. The overall process involves first acquiring the digital image. This image may be a digital image to be edited within a photo processing software suite or acquired by a device such as a camera or scanner. Once acquired the genre associated with the image is identified. This identification may be based on information contained within the image being imported into a photo processing software suite, may be identified by analyzing the composition and makeup of the digital image, or the actual hardware setting associated with acquiring the image with a scanner, camera or other like device. Processes corresponding to the genre are selected and applied to the image to produce a professional quality enhanced digital image.

### CROSS-REFERENCE TO RELATED APPLICATION

This application claims the benefit of priority to U.S. Provisional Patent Application No. 60/541,682 entitled “System and Method to Enhance the Quality of Digital Images”, filed on Feb. 4, 2004, and is incorporated herein by reference in its entirety.

### TECHNICAL FIELD OF THE INVENTION

The present invention generally relates to the processing of a digital image before the image is used for presentation. More specifically, digital images from a digital camera or scanner benefit greatly from numerous enhancement techniques before being used for presentation. The processes described within result in great simplification, significant time-savings, and consistently excellent results for the processing of digitally captured or scanned images.

### BACKGROUND OF THE INVENTION

Digital photography nearly always benefits and often requires that the images be enhanced or further processed beyond mere image acquisition. This is true of both traditional photography and digital photography. A large portion of a photographer¹s work actually involves the enhancement of the photographs taken, prior to their presentation.

In digital photography several methods may be employed to enhance digital images. These methods may include sharpening, reducing noise, adjusting color, setting white point, and setting black point. These processes may vary from photograph to photograph. Thus, each photograph involves a great deal of labor-intensive work for the photographer to perform on a digital image prior to presentation of the digital image to the end user.

Previously, one has not been able to combine or standardize this enhanced processing, as the actual enhancements necessary depend on the composition of the individual photograph. In addition to the composition, the acquiring devise associated with the digital image can impact which enhancements need to be performed. Therefore, a need exists to standardize enhancement processes applied to digital images to produce professional quality images.

### SUMMARY OF THE INVENTION

The present invention provides a system process and method that substantially eliminates or reduces disadvantages and problems associated with previously developed systems and methods used for preparing images for presentation. The present invention provides numerous processes with which to enhance the quality of digital images. This invention professional quality enhancements that can be made simply, reliably and very quickly with a process that is easily and intuitively chosen based on the type or genre of digital image. Several methods for enhancing digital images are provided in each of the following categories of Sharpening, Reducing Noise, Adjusting Tone Range, Setting White Point, Setting Black Point, and Adjusting Color.

A user may, with a single click, select a group of actions that would be appropriate for a specific type or genre of image. For example, the user could decide to process the image(s) with the Portrait actions or processing steps. In that event, one series of actions would automatically be chosen from each of the categories (Sharpening, Reducing Noise, Adjusting Tone Range, Setting White Point, Setting Black Point, and Adjusting Color) that would be appropriate for a portrait. The series of actions or processing steps could then run automatically or could stop at key points for the user's creative input. This formatted process results in simplification, significant time-savings, excellent quality and consistent results for the processing of digitally captured or scanned images.

In addition to being used on a single image, this process may be applied to a batch of several images or even to all the images in a digital movie. The processes can be used as actions in photo processing software applications such as but not limited to Adobe Photoshop®, Adobe After Effects®, Gimp®. The processes can be written into another program, be used to create a stand-alone program or be written as a plug-in for existing image processing software such as Adobe Photoshop® or Photoshop LE®. The processes can be used or incorporated into a number of other applications or devices including but not limited to digital cameras, scanners, image setters, plate makers, printers, monitors, projectors or other image capture or presentation devices.

Numerous products relate to enhancing digital images. These include stand-alone packages that perform the following types of enhancements sharpening, reducing noise, adjusting tone range, setting white point, setting black point, and adjusting color. These actions may also be incorporated either stand-alone or work as actions or plug-ins within other applications to achieve enhancements on most or all of the above-identified enhancements.

The processes can be used in a number of other applications or devices including but not limited to digital cameras, scanners, image setters, plate makers, printers, monitors, projectors or other image capture or presentation devices. Additionally using the EXIF data embedded in a digital image the user of a camera or scanner could embed data in the file that could be used to automatically choose one of these sets of steps for preparing the image for presentation.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 2 is a flowchart showing the respective steps in a image processing method of the invention to improve image sharpness on edges only;

FIG. 3 is a flowchart showing the respective steps in a image processing method of the invention to improve image sharpness on edges and slightly overall;

FIG. 4 is a flowchart showing the respective steps in a image processing method of the invention to improve image sharpness on edges and dramatically overall;

FIG. 5 is a flowchart showing the respective steps in a image processing method of the invention to reduce noise very slightly (Level 1 out of 6);

FIG. 6 is a flowchart showing the respective steps in a image processing method of the invention to reduce noise slightly (Level 2 out of 6);

FIG. 7 is a flowchart showing the respective steps in a image processing method of the invention to reduce noise moderately (Level 3 out of 6);

FIG. 8 is a flowchart showing the respective steps in a image processing method of the invention to reduce noise moderately (Level 4 out of 6);

FIG. 9 is a flowchart showing the respective steps in a image processing method of the invention to reduce noise heavily (Level 5 out of 6);

FIG. 10 is a flowchart showing the respective steps in a image processing method of the invention to reduce noise very heavily (Level 6 out of 6);

FIG. 11 is a flowchart showing the respective steps in a image processing method of the invention to adjust tone range;

FIG. 12 is a flowchart showing the respective steps in an image processing method of the invention to adjust tone range for a backlit photo;

FIG. 13 is a flowchart showing the respective steps in a image processing method of the invention to set white point and black point;

FIG. 14 is a flowchart showing the respective steps in a image processing method of the invention to adjust color for slightly more saturation;

FIG. 15 is a flowchart showing the respective steps in a image processing method of the invention to adjust color for more dramatic sky for landscapes;

FIG. 16 is a flowchart showing the respective steps in a image processing method of the invention to adjust color for portraits;

FIG. 17 is a flowchart showing the respective steps in a image processing method of the invention to adjust color for accurate product color;

FIG. 18 is a flowchart showing the respective steps in a image processing method of the invention to adjust color for vibrant product color;

FIG. 19 is a flowchart showing the respective steps in a image processing method of the invention to adjust color for sports;

FIG. 20 is a flowchart showing the respective steps in a image processing method of the invention to adjust color for stylized color for warm black and white;

FIG. 21 is a flowchart showing the respective steps in a image processing method of the invention to adjust color for stylized color for a sepia-toned effect;

FIG. 22 is a flowchart showing the respective steps in a image processing method of the invention to adjust color for stylized vivid bright color;

FIG. 23 is a flowchart showing the respective steps in a image processing method of the invention to adjust color for a stylized warmer color effect;

FIG. 24 is a flowchart showing the respective steps in a image processing method of the invention to adjust color for weddings;

FIG. 25 is a graph showing the amount of sharpening obtained by the various sharpening processes;

FIG. 26 is a graph showing the amount of noise reduction obtained by the various noise reduction processes;

FIG. 27 is a graph showing the results of the changes to color obtained by the various color processes;

FIG. 28 is a graph showing how several of the processes can be combined and then applied in a way to be suitable for a specific type or genre of digital image such as family snapshots;

FIG. 29 is a graph showing how several of the processes can be combined and then applied in a way to be suitable for a specific type or genre of digital image such as landscapes;

FIG. 30 is a graph showing how several of the processes can be combined and then applied in a way to be suitable for a specific type or genre of digital image such as portraits;

FIG. 31 is a graph showing how several of the processes can be combined and then applied in a way to be suitable for a specific type or genre of digital image such as product photo that would benefit from vibrant color;

FIG. 32 is a graph showing how several of the processes can be combined and then applied in a way to be suitable for a specific type or genre of digital image such as product photo that would benefit from accurate color;

FIG. 33 is a graph showing how several of the processes can be combined and then applied in a way to be suitable for a specific type or genre of digital image such as would benefit from an old fashion Sepia appearance;

FIG. 34 is a graph showing how several of the processes can be combined and then applied in a way to be suitable for a specific type or genre of digital image such as Sports;

FIG. 35 is a graph showing how several of the processes can be combined and then applied in a way to be suitable for a specific type or genre of digital image such as would benefit from very bright and vivid color;

FIG. 36 is a graph showing how several of the processes can be combined and then applied in a way to be suitable for a specific type or genre of digital image such as would benefit from a warmer look;

FIG. 37 is a graph showing how several of the processes can be combined and then applied in a way to be suitable for a specific type or genre of digital image such as wedding;

FIGS. 38 through 49 are graphs that represent what the various processes that operate on a digital image in accordance with the present invention; and

FIG. 50 provides a functional block diagram of an embodiment of the present invention.

### DETAILED DESCRIPTION OF THE INVENTION

Preferred embodiments of the present invention are illustrated in the FIGUREs, like numerals being used to refer to like and corresponding parts of the various drawings and processes.

The invention enhances the quality of digital images. This allows professional quality enhancements to be made simply, reliably and very quickly with a process that is easily and intuitively chosen based on the type or genre of digital image. The type or genre of the image can be contained within information stored within the digital image. Several methods for enhancing digital images include sharpening, reducing noise, adjusting tone range, setting white point, setting black point, and adjusting color. By bundling those processes, the user may, with a single click, select a group of actions appropriate for a specific type or genre of image. For example, the user could decide to process the image(s) with the portrait actions or processing steps. In that event one series of actions would automatically be chosen from each of the categories (sharpening, reducing noise, adjusting tone range, setting white point, setting black point, and adjusting color) that would be appropriate for a portrait. The series of actions or processing steps are then run with potential stops at key points for the user's creative input. In addition to being used on a single image, this process can be applied to a batch of images or even to all the images within a digital movie. The processes also can be incorporated into a number of other applications or devices including but not limited to digital cameras, scanners, image setters, plate makers, printers, monitors, projectors or other image capture or presentation devices to process the raw image within the device.

FIG. 1 provides a logical diagram illustrating the process and overall methodology associated with present intervention. In Step 12 the image is acquired. This image may be a digital image to be edited within a photo processing software suite or acquired by a device such as a camera or scanner. Once the image is acquired the genre associated with the image is identified in step 14. This identification may be based on information contained within the image being imported into a photo processing software suite, may be identified by analyzing the composition and makeup of the digital image, or the actual hardware setting associated with acquiring the image with a scanner, camera or other like device. In step 16 processes corresponding to the genre are selected. These processes are applied to the image in step 18 to produce a professional quality enhanced digital image in step 20.

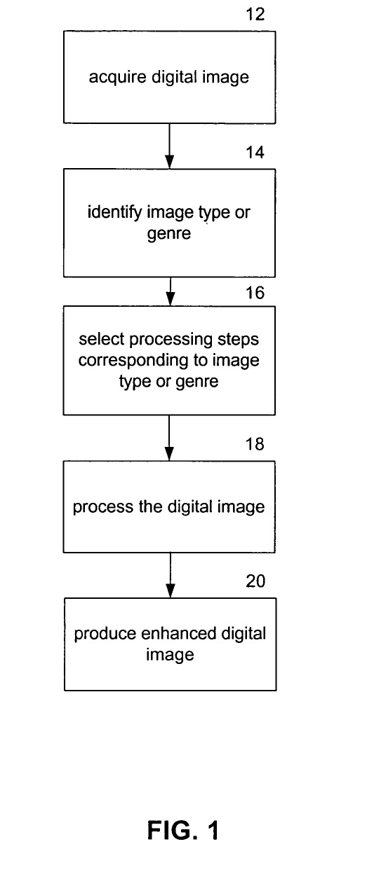

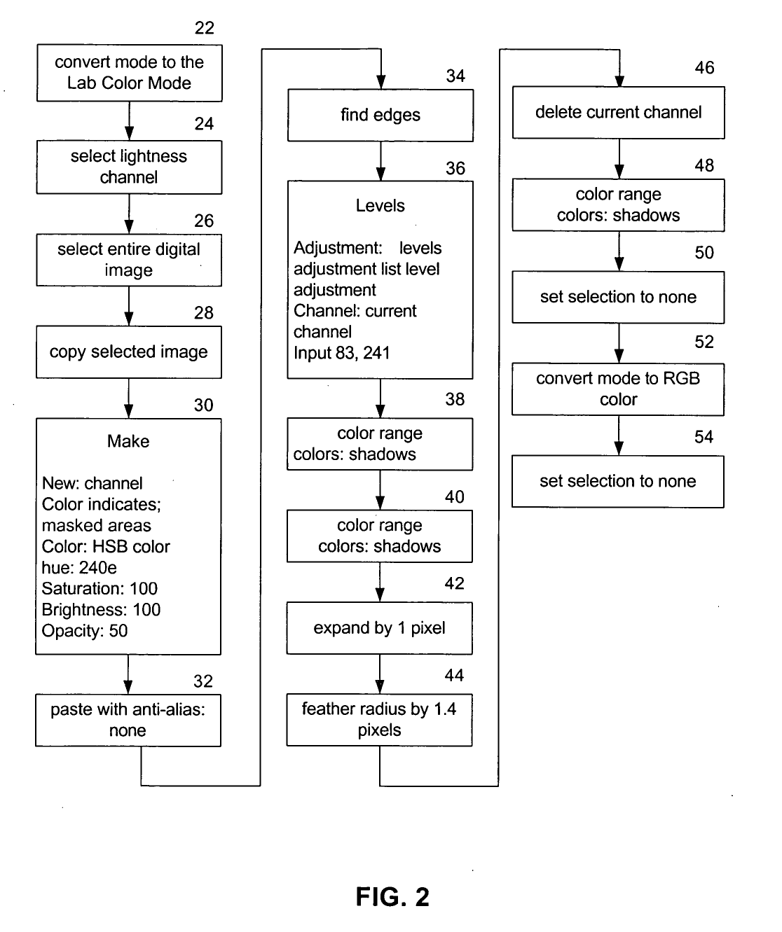

FIG. 2 describes the processes applied to a digital image to improve image sharpness on edges only within a photo processing suite such as Adobe Photoshop® automate the following commands or effect the image in a similar way with a stand-alone application or other software.

Step 22 converts the image mode from RGB to lab color mode. This step 24 selects the lightness channel and set selection to all in step 26, prior to copying the selection in step 28. A new channel is created in step 30. A mask created on the new channel with the following color specifications of color model of HSB color hue of 240°, saturation of 100, brightness of 100, opacity of 50. The masked area is posted with no anti-aliasing in step 32. Areas of dramatic contrast difference are located to find the edges and make them a selection in step 34.

Step 36 increases the contrast in the channel by adjusting the levels based on changing input level from 83 to 241 on a scale of 0 to 255. Step 38 elects the color range defined as colors between 0 and 60, also known as shadows. That selection is expanded by 1 pixel in step 40 prior to feathering the edges of that selection by a radius of 1.4 pixels in step 42. At step 44, the current channel is selected while retaining the selection of the area. Step 46 applies an unsharp mask in the amount of 78%, with a radius of 1.5 pixels, and a threshold of 2. The selection is set to none in step 48. Next, the image is returned to the RGB color mode in step 50. Selection set to none is verified in step 52.

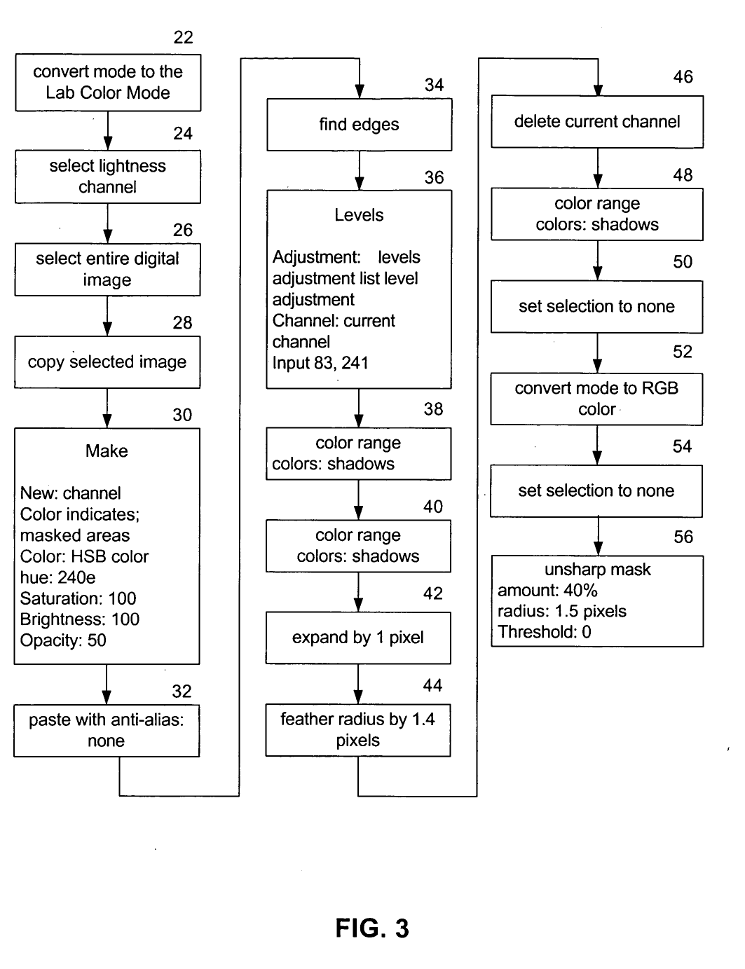

FIG. 3 describes the processes to apply to a digital image to improve image sharpness on edges and slightly overall across the entire image. Steps 22 through 52 are repeated as described above. Step 54 then automates the following commands or effects to the image in a similar way with a stand-alone application or other software. Step 56 verifies the selection and applies an unsharp mask to the entire image in the amount of 40%, with a radius of 1.5 pixels, and a threshold of 0.

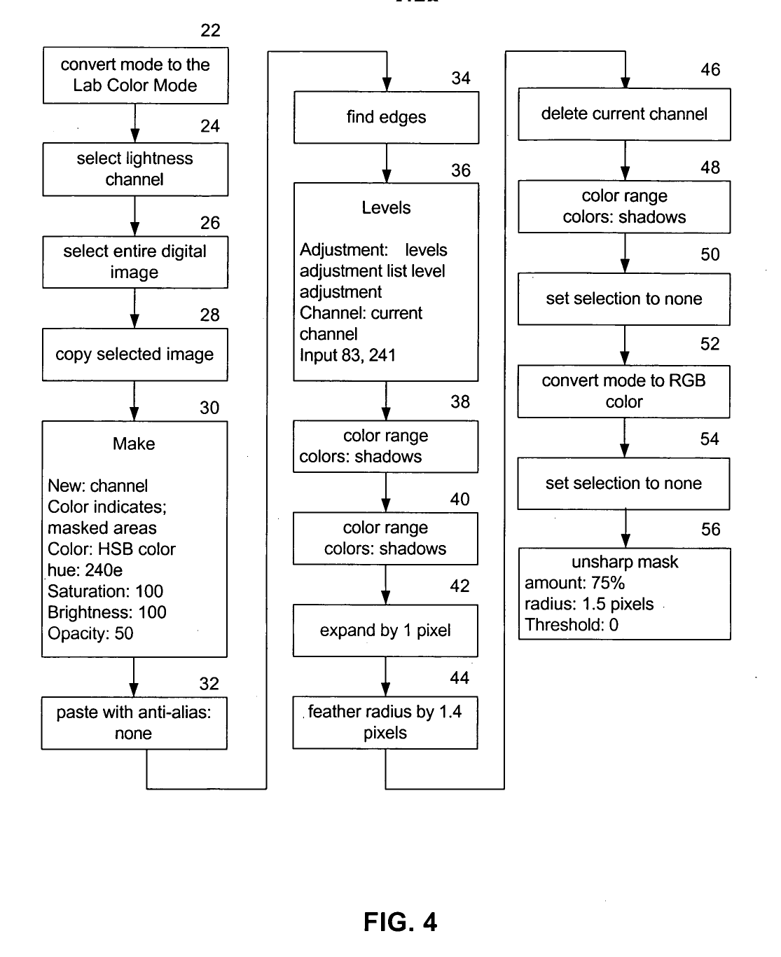

FIG. 4 describes the processes to apply to a digital image to improve image sharpness on edges and slightly overall. Steps 22 through 52 are repeated as previously described. Step 56 verifies the selection and applies an unsharp mask to the entire image in the amount of 75%, with a radius of 1.5 pixels, and a threshold of 0.

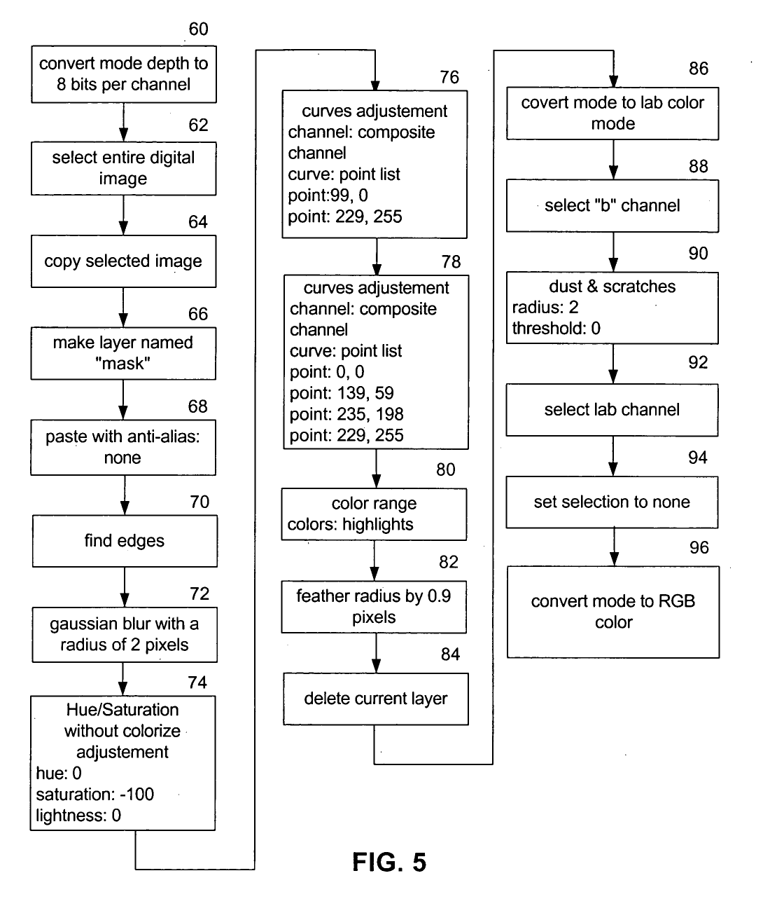

FIG. 5 describes the processes to apply to a digital image to reduce noise very slightly (Level 1 out of 6). In Adobe Photoshop®, the following commands are executed to affect the image in a similar way with a stand-alone application or other software. Step 60 converts color depth mode to 8 bits per channel. Then step 62 sets selection to all. The selection is copied in step 64. A new layer with no anti-alias, using the without below feature, using the layer name “Mask” is made in step 66 and 68. Areas of dramatic contrast difference are located in step 70 and make them a selection. Step 72 applies a Gaussian blur with a radius of 2 pixels. Step 74 applies a hue/saturation adjustment without colorize. The hue/saturation adjustment should be hue of 0, saturation of −100, lightness of 0. Increase the contrast by applying a tone curves adjustment by moving point 99 to 0 and point 229 to 255. Apply the following curves adjustment of move point 0 to 0, point 139 to 59, point 235 to 198, and point 255 to 255. Step 80 selects colors in the range of 190 to 255 (highlights). The selection is feathered with a radius of 0.9 pixels in step 82. Steps 84 deletes the current layer but maintains selected area. Next, step 86 converts mode to lab color mode. The b channel is selected in step 80 and either Gaussian blur with a radius of 1 or applies a dust & scratches filter with a radius of 2, and a threshold of 0 is applied in step 90. Select composite lab channel in step 92 and set selection to none in step 94. The convert mode to back to RGB color mode in step 96.

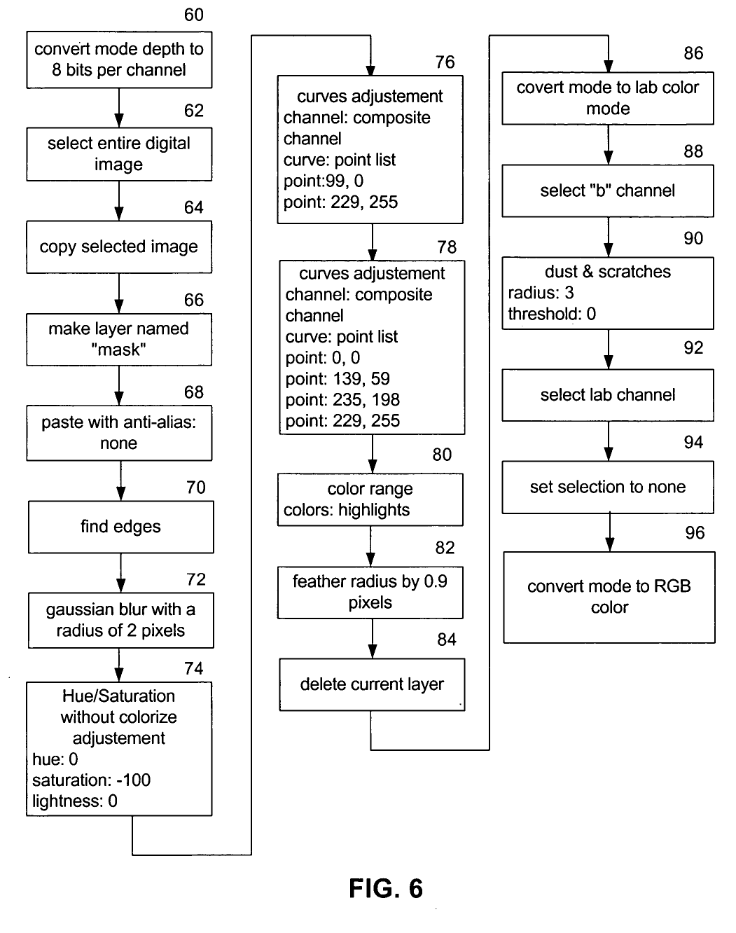

FIG. 6 describes the processes to apply to a digital image to reduce noise slightly (Level 2 out of 6). Steps 60 through 96 are repeated as described above. However, step selects the b channel and either Gaussian blur with a radius of 1.5 or apply a dust & scratches filter with a radius of 3, and a threshold of 0.

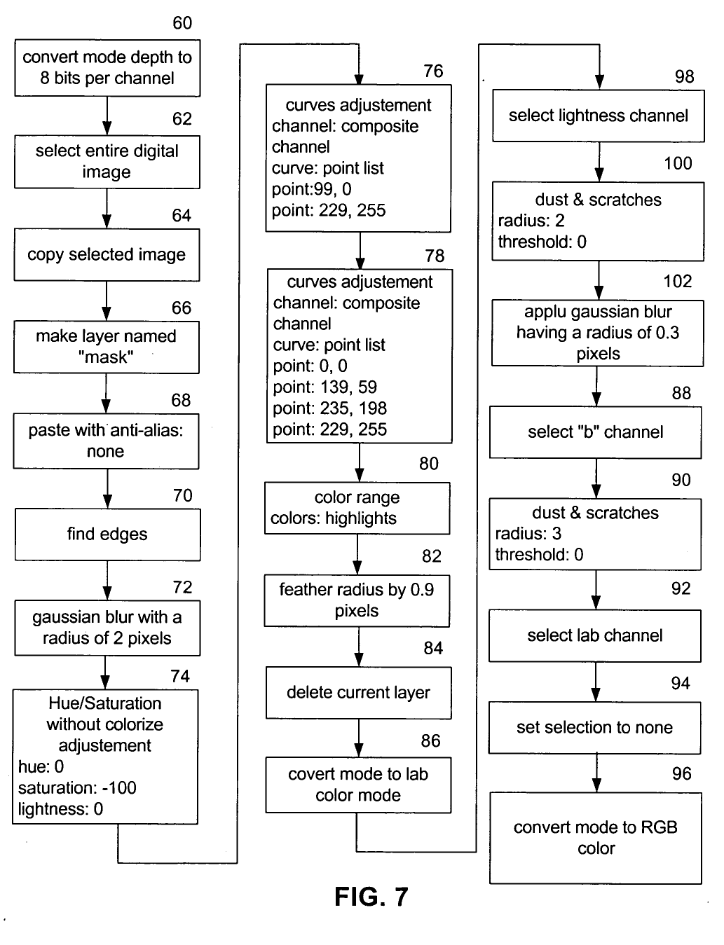

FIG. 7 describes the processes to apply to a digital image to reduce noise moderately (Level 3 out of 6). Steps 60 through 76 are repeated as previously described. However, additional steps 98, 100 and 102 are repeated between steps 86 and 88. Step 90 selects the lightness channel and applies either Gaussian blur with a radius of 1.5 or a dust and scratches filter with a radius of 2 pixels, and a threshold of 0, in steps 100 and 102.

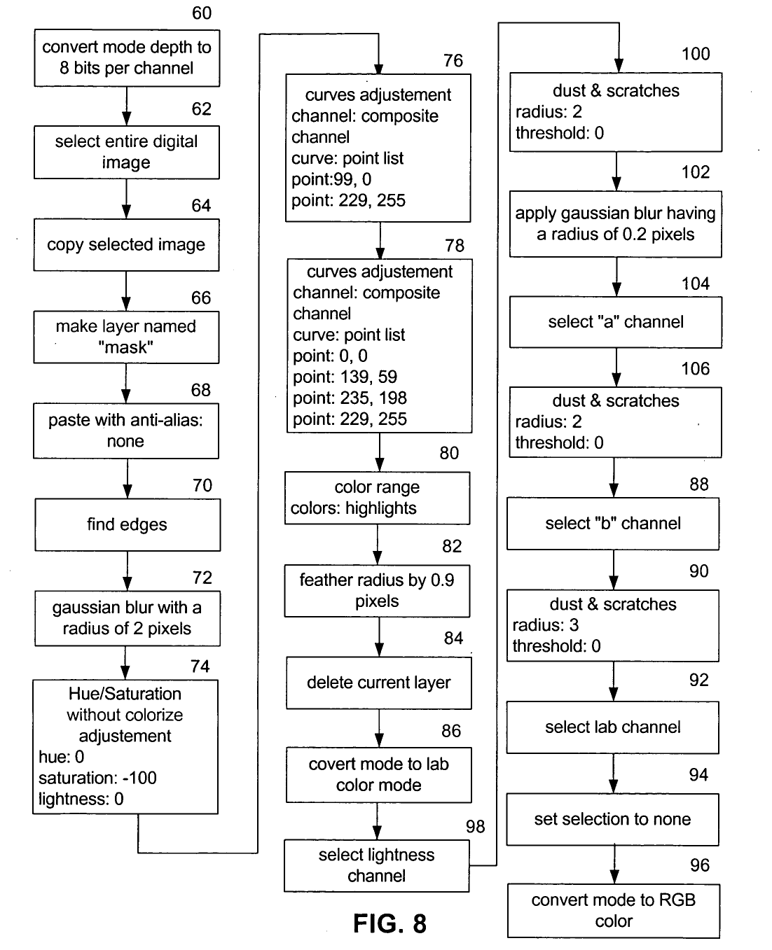

FIG. 8 describes the processes to apply to a digital image to Reduce Noise a little more than Moderately (Level 4 out of 6). Steps 60 through 96 are applied as previously described. Steps 98 through 106 are applied between steps 86 and 88. Step 98 selects the lightness channel. Then steps 100 and 102 apply a Gaussian blur with a radius of 0.2 pixels, and a dust and scratches filter with a radius of 2 pixels and a threshold of 0. Step 104 selects “a” channel and applies either a Gaussian blur with a radius of 1.5 pixels or a dust and scratches filter with a radius of 2 pixels, and a threshold of 0 in step 106.

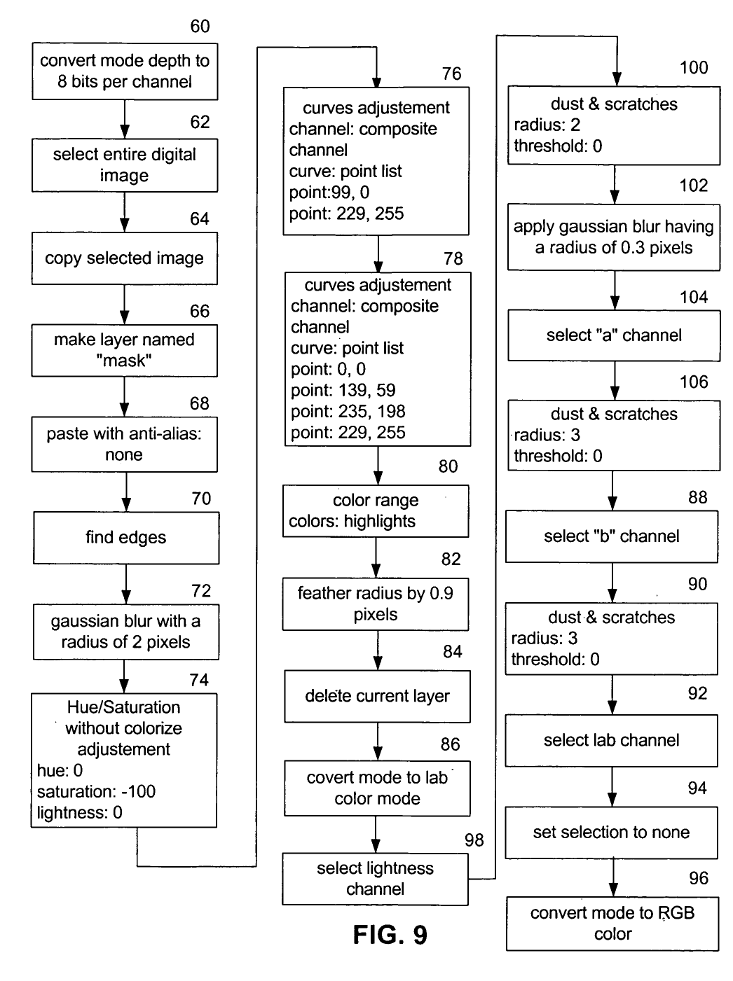

FIG. 9 describes the processes to apply to a digital image to reduce noise heavily (Level 5 out of 6). This process substantially repeats the steps of FIG. 8. Steps 60 through 96 are applied as previously described. Steps 98 through 106 are applied between steps 86 and 88. Step 98 selects the lightness channel. Then steps 100 and 102 apply a Gaussian blur with a radius of 0.3 pixels, and a dust and scratches filter with a radius of 3 pixels and a threshold of 0. Step 104 selects “a” channel and applies either a Gaussian blur with a radius of 1.5 pixels or a dust and scratches filter with a radius of 3 pixels, and a threshold of 0 in step 106.

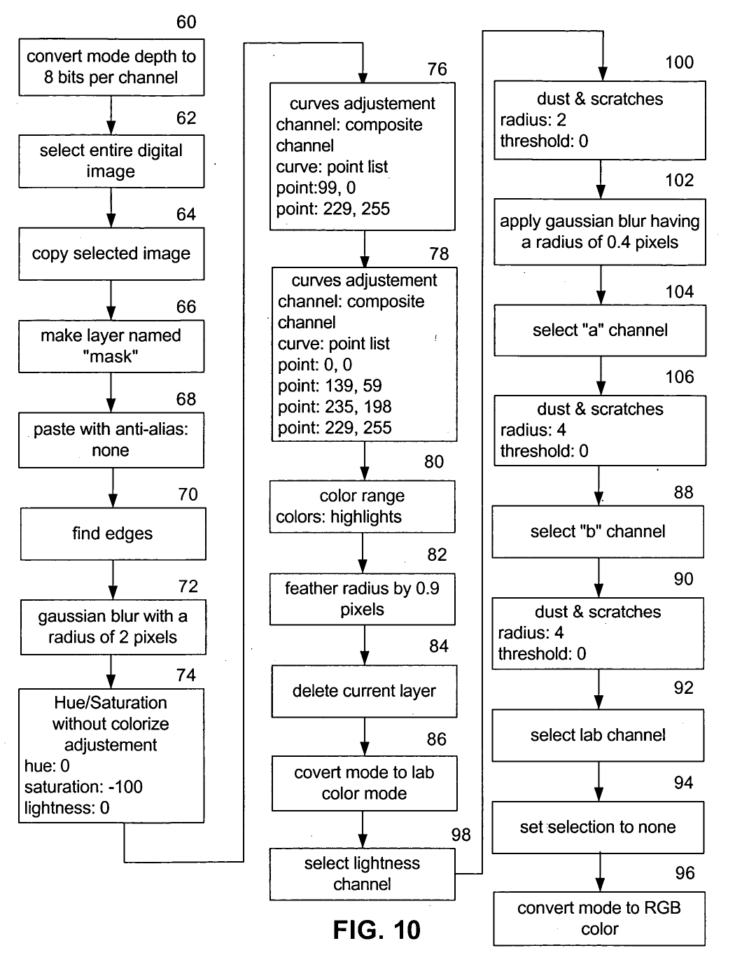

FIG. 10 describes the processes to apply to a digital image to Reduce Noise Very Heavily (Level 6 out of 6). This process substantially repeats the steps of FIG. 8. Steps 60 through 96 are applied as previously described. Steps 98 through 106 are applied between steps 86 and 88. Step 98 selects the lightness channel. Then steps 100 and 102 apply a Gaussian blur with a radius of 0.4 pixels, and a dust and scratches filter with a radius of 4 pixels and a threshold of 0. Step 104 selects “a” channel and applies either a Gaussian blur with a radius of 1.5 pixels or a dust and scratches filter with a radius of 3 pixels, and a threshold of 0 in step 106.

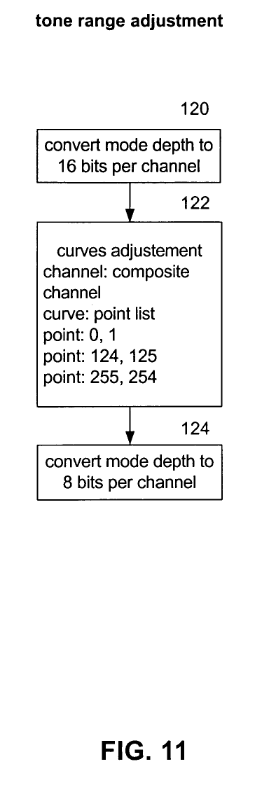

FIG. 11 describes the processes applied to a digital image to adjust tone range. This is unconventional in respect to the adjustment being made in the 16 bits per channel mode. Using this mode to adjust curves allows for large moves to be made without the typical penalty of image posterization that can occur when done in 8 bit per channel mode. The following steps alter the image in a similar way with a stand-alone application or other software. Step 120 converts color depth mode to 16 bits per channel. Tone curves are applied to adjust the composite channel by moving point 0 to 1 or 0, point 124 to 125, and point 255 to 254 or 255 in step 122. Next, toggle this step as needing user input before proceeding. Step 124 resumes automated play and return file to 8 bit per channel mode.

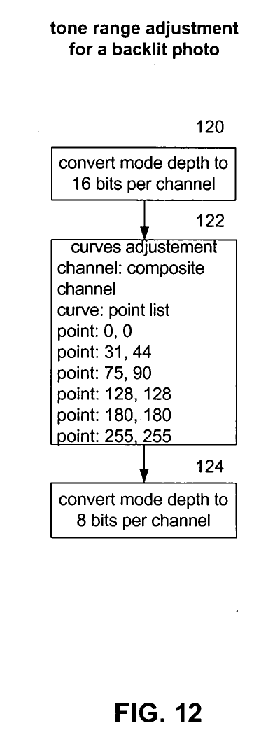

FIG. 12 applies similar processes to a digital image to adjust tone range for a backlight photo. Here the tone curves adjustment to the composite channel of step 122 is applied by moving point 0 to 0, point 31 to 44, point 75 to 90, point 128 to 128, point 180 to 180, and point 255 to 255.

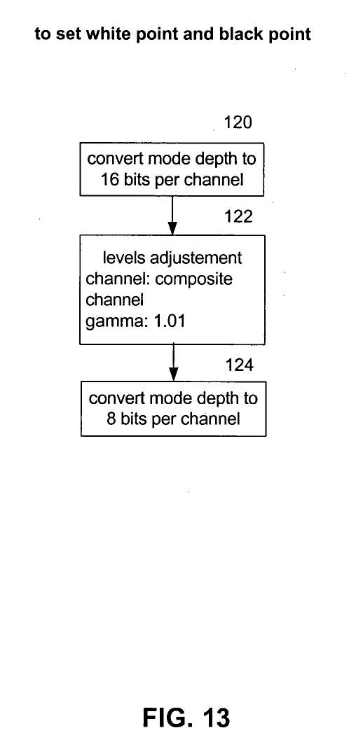

FIG. 13 describes processes similar to FIGS. 11 and 12 to set white point and black point. Here, step 122 applies a levels adjustment to the composite channel by setting gamma to 1.01, which is the same as the smallest possible mid-tone adjustment.

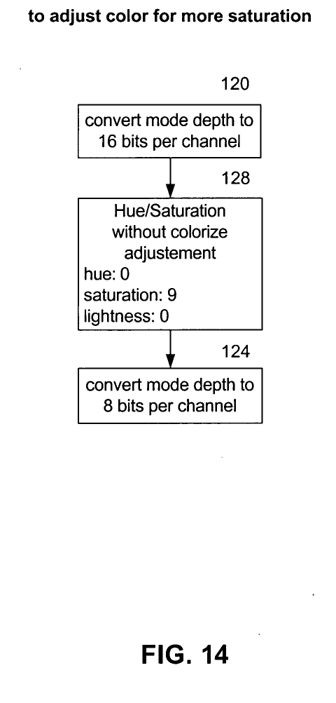

FIG. 14 describes a process applied to a digital image to adjust color for slightly more saturation for a particular genre such as landscapes. As in previous processes, step 120 converts color depth mode to 16 bits per channel. Step 128 adjusts Hue/saturation without colorize and without change to hue or lightness and increases saturation 9%. Step 124 returns to an 8 bit per channel mode.

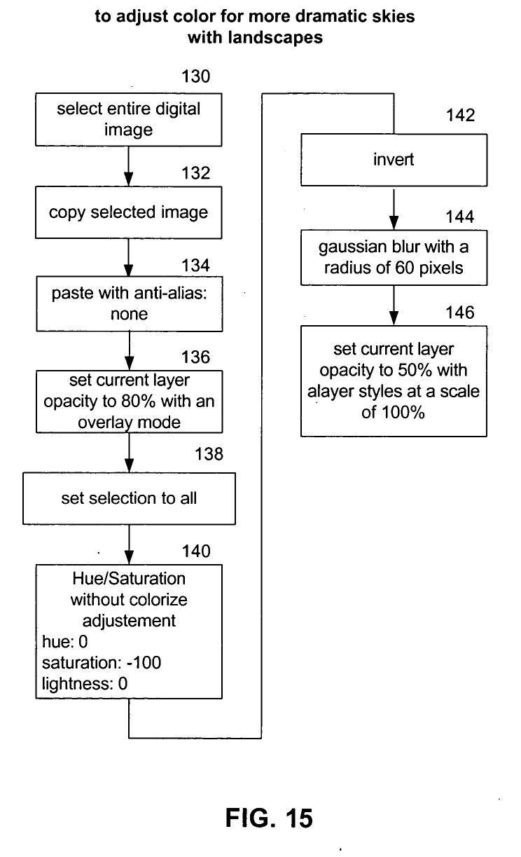

FIG. 15 provides a logic flow diagram to be applied to a digital image to adjust color and contrast in certain areas for more dramatic sky for landscapes. Step 30 selects the entire selection. This selection is copied and pasted in step 132 and 134, respectively. Step 136 sets the current layer to layer opacity 80%, in an overlay mode. The image is selected again in step 138 prior to the adjustment of hue/saturation without colorize as follows of hue 0, saturation −100, and lightness 0 in step 140. Step 142 applies an inverts top layer and Gaussian blur with a radius of 60 pixels in step 144. Step 146 sets the top layer to layer opacity of 50% and then optionally flattens layers.

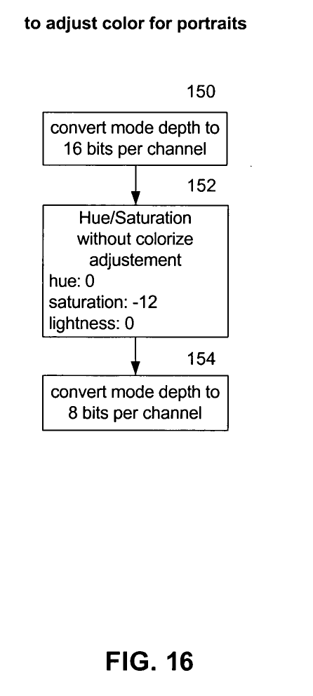

FIG. 16 describes processes to be applied to a digital image to adjust color for portraits. This processing begins by converting the color depth mode to 16 bits per channel in step 150. Step 152 adjusts Hue/saturation without colorize and without change to hue or lightness and decreases saturation 12%. Return file to 8 bit per channel mode.

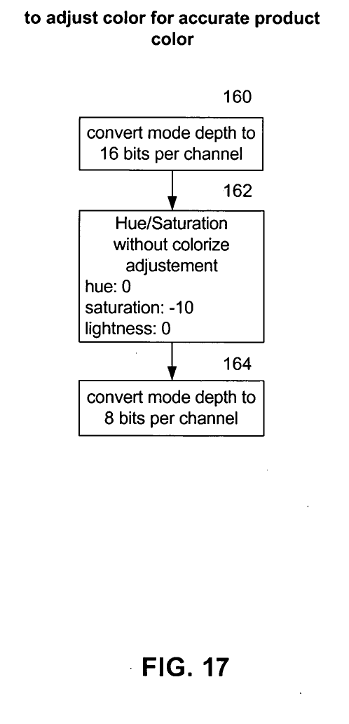

FIG. 17 describes the processes to be applied to a digital image to adjust color for accurate product color. Step 160 converts color channel to a 16 bit per channel mode. Then step 162 adjust Hue/saturation without colorize and without change to hue or lightness and decrease saturation by 10%. The digital image is returned file to 8 bit per channel mode in step 164.

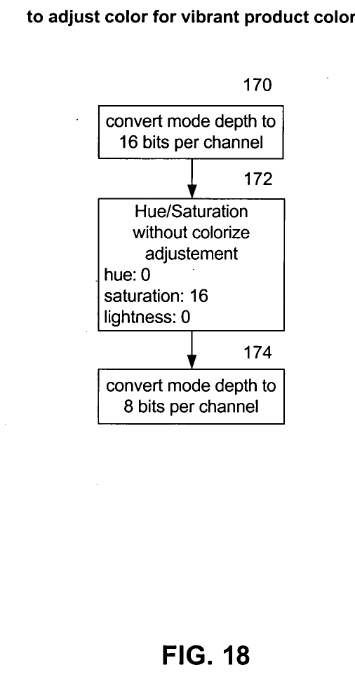

FIG. 18 modifies the previously described process to adjust color for vibrant product color. Step 170 converts color channel to a 16 bit per channel mode. Here, during the adjust hue/saturation without colorize and without change to hue or lightness of step 172. Saturation is increased by 16%. Prior to returning the image to an 8 bit per channel mode in step 174.

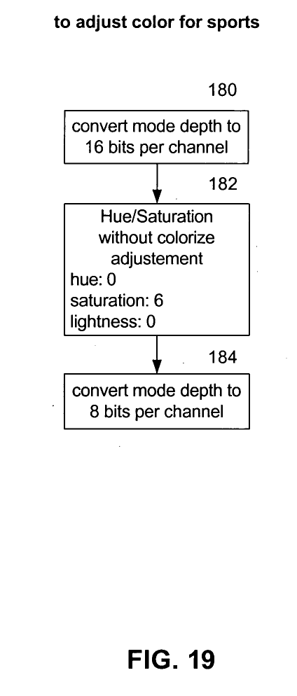

FIG. 19 describes the processes to apply to a digital image to adjust color for sports. Step 180 converts color depth mode to 16 bits per channel. Here, step 182 adjusts hue/saturation without colorize and without change to hue or lightness and increases saturation by 6%. Step 184 then returns the image to an 8 bit per channel mode.

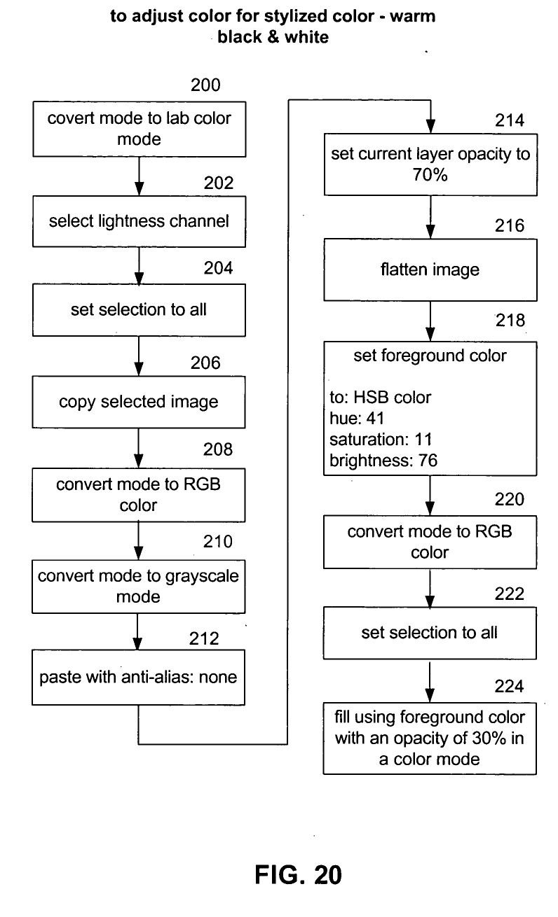

FIG. 20 describes the processes applied to a digital image to adjust color for a warm black and white result. Step 200 converts mode to lab color mode. Then, step 202 selects lightness channel and selects the entire image in step 204. This is corrected in step 206. Step 208 converts mode to RGB color mode and then to a grayscale mode in step 210. The image is pasted in step 212 with no anti-aliasing. Step 214 set the current layer to layer opacity 70%. The image is flattened in step 216 Foreground color is set to HSB color model color with the following color specifications of hue 41°, saturation 11, brightness 76 in step 218. The image is returned to RGB color mode. Step 224 fills using foreground color at opacity of 30% in color only mode.

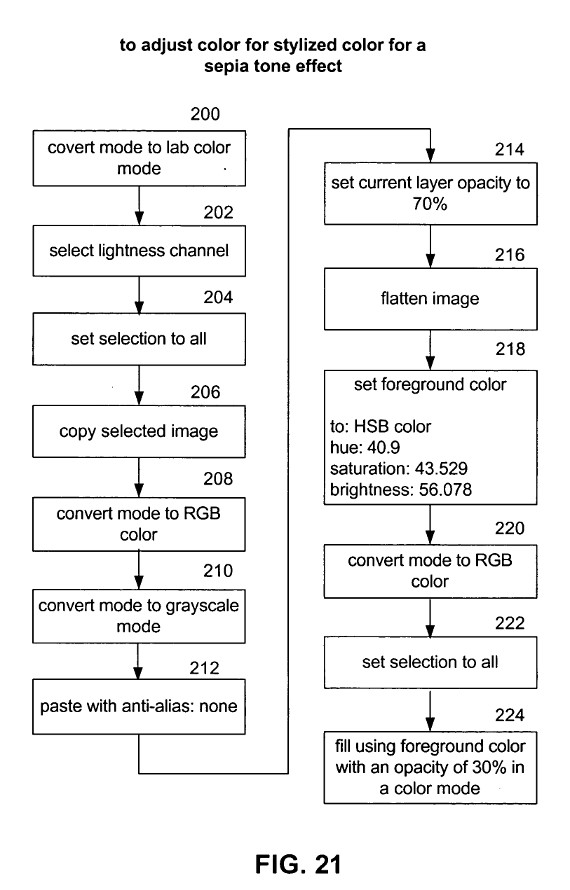

FIG. 21 repeats steps 200 through 224 to adjust color for a sepia-toned effect. Here, step 218 sets the foreground color to HSB color model color with the following color specifications of hue 40.9°, saturation 43.529, brightness 56.078. Convert mode to RGB color mode. Step 224 using foreground color at an opacity of 30% in color only mode.

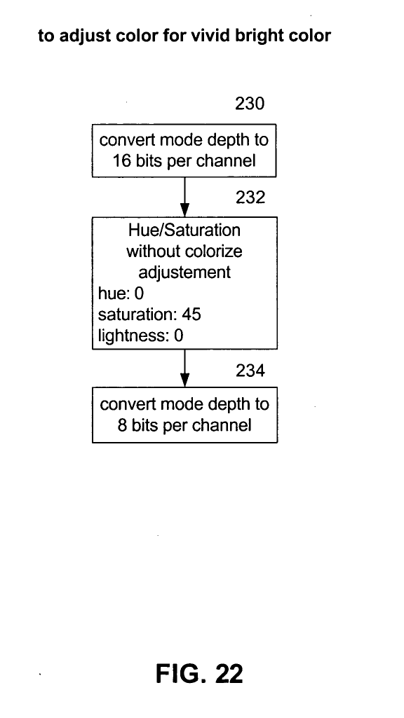

FIG. 22 describes a process to adjust color for vibrant product color. Step 238 converts color depth mode to 16 bits per channel. Then, step 232 adjusts hue/saturation without colorize and without change to Hue or lightness and increases saturation by 45%. Step 234 then returns the digital image to an 8 bit per channel mode.

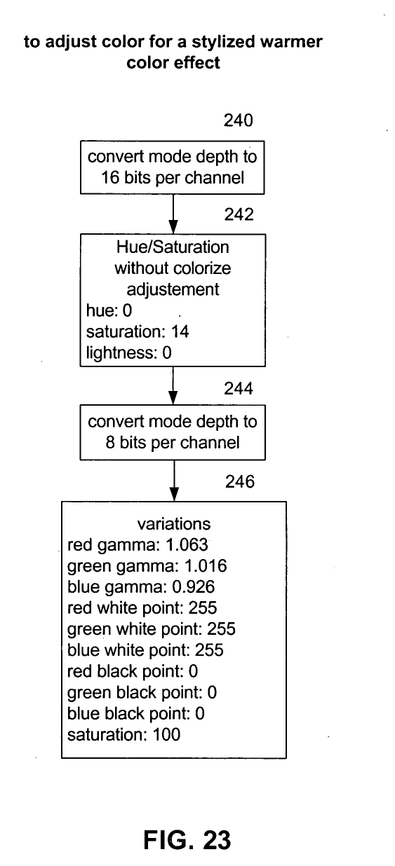

FIG. 23 describes the processes to adjust a digital image to adjust color for a stylized warmer color effect. Step 240 converts color depth mode to 16 bits per channel. Then, step 242 adjusts hue/saturation without colorize and without change to hue or lightness and increases saturation by 14%. The file returns to an 8 bit per channel mode in step 244. Step 264 adjusts variations by changing red gamma from 1 to 1.063, change green gamma from 1 to 1.016 and change blue gamma from 1 to 0.926. No changes are affected to any of the white points, black points or saturation.

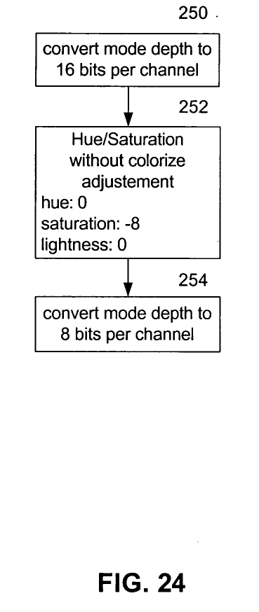

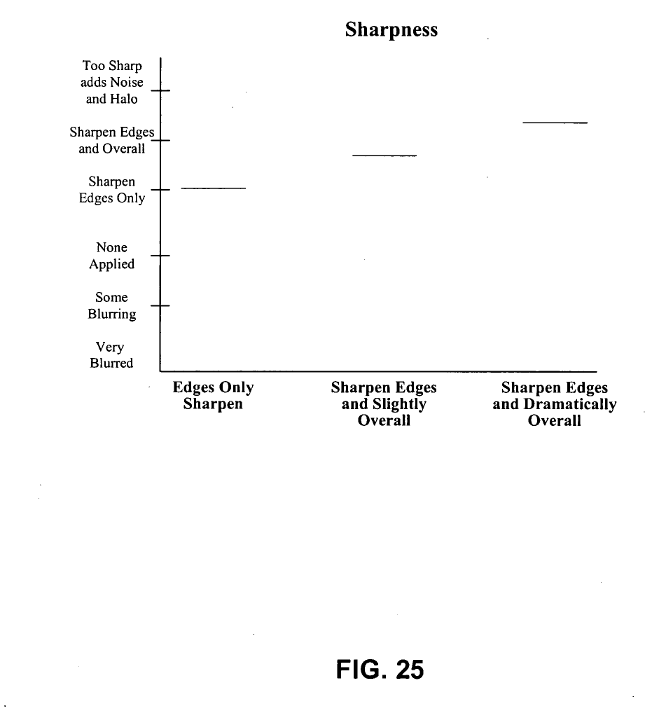

FIG. 24 describes processes to adjust color for weddings. Step 250 converts color depth mode to 16 bits per channel. Then, step 252 adjusts hue/saturation without colorize and without change to hue or lightness and decreases saturation by 8%. Step 254 then returns the file to 8 bit per channel mode. FIG. 25 further describes the variety of sharpening processes and how they relate to one another in terms of the amount of sharpness applied by the three different sharpening processes. The edges only sharpen routine 260 does as its name implies in that the processes only sharpens edges (areas of high contrast) in the digital image. One benefit from this sharpening method is that no sharpening is applied to areas of generally smooth tone. Some examples of smooth tone areas that benefit from having no sharpening applied are skin tones and clear blue sky. The sharpen edges and slightly overall process 262 also does simply what its name implies. The process first sharpens edges and then applies a light sharpening over the entire image. The sharpen edges and dramatically overall process 264 also does simply what its name implies. The process first sharpens edges and then applies a dramatic sharpening over the entire image.

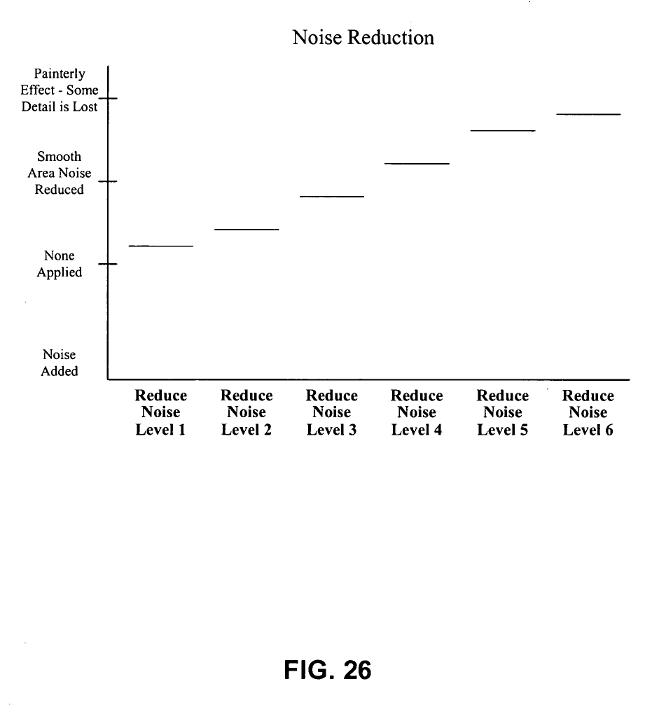

FIG. 26 further describes the variety of noise reduction processes and how they relate to one another in terms of the amount of noise reduction applied by six different noise reduction processes. Reduce noise level 1 is a process whereby partial reduction of errant pixel color is done while very careful attention is paid to not create any false color edges or posterization of smooth tone areas. The six levels of noise reduction step incrementally towards a situation at level six where the noise reduction process does a great deal of noise reduction in a way that results in noticeable posterization of smooth tone areas and some slight color alteration especially in areas of high contrast.

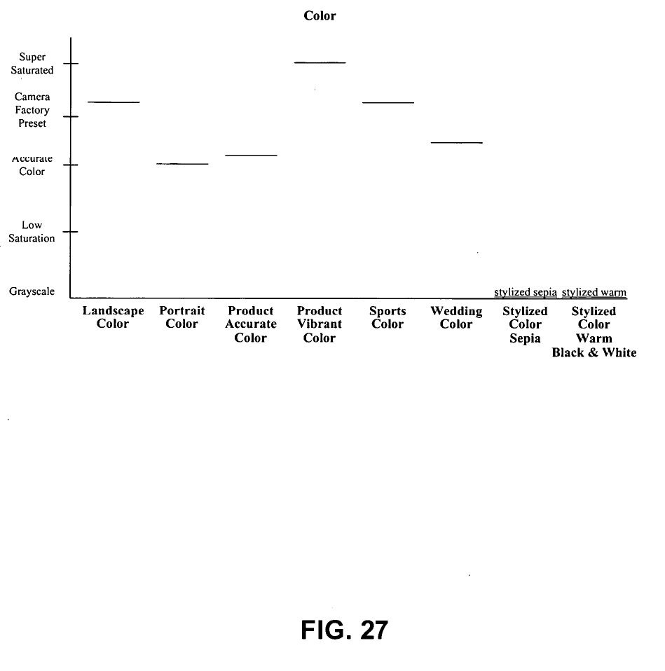

FIG. 27 further describes the variety of color processes and how they relate to one another in terms of the amount and type of color change applied by eleven different color processes. The left axis of the graph represents no color saturation at the bottom and much exaggerated color saturation at the top. Most digital cameras factory default setting is for slightly more saturated color than accurate color. The reason for this is that most consumers like a more saturated and “brighter” color representation in their photos. While this can result in pleasing color at a glance, it also results in skin tones that tend to be a little over-saturated. Over-saturated skin tones look generally ruddy or unnatural in appearance. From left to right along the horizontal axis are graphic comparisons for each of eight color adjustment processes. The process as described by FIG. 14 for landscape adjusts color saturation to increase saturation slightly without effect to hue or luminosity. The process described by FIG. 16 for portraits adjusts color saturation to decrease saturation moderately without effect to hue or luminosity. The process as described by FIG. 17 for product accurate color adjusts color saturation to decrease saturation, almost as much as the Portrait process, again without effect to hue or luminosity. The process as described by FIG. 18 for vibrant product color adjusts color saturation to increase saturation significantly without effect to hue or luminosity. The process as described by FIG. 19 for sports adjusts color saturation to increase saturation very slightly without effect to hue or luminosity. The process as described by FIG. 24 for wedding adjusts color saturation to decrease saturation slightly but not quite as much as portrait without effect to hue or luminosity. The process as described by FIG. 20 for stylized color-warm black and white adjusts color saturation to decrease saturation completely without effect to hue or luminosity. Then to the process gives the resultant grayscale image a slightly warm tone. The process as described by FIG. 21 for stylized color-sepia adjusts color saturation to decrease saturation completely without effect to hue or luminosity. Then the process gives the resultant grayscale image an antiqued very warm tone.

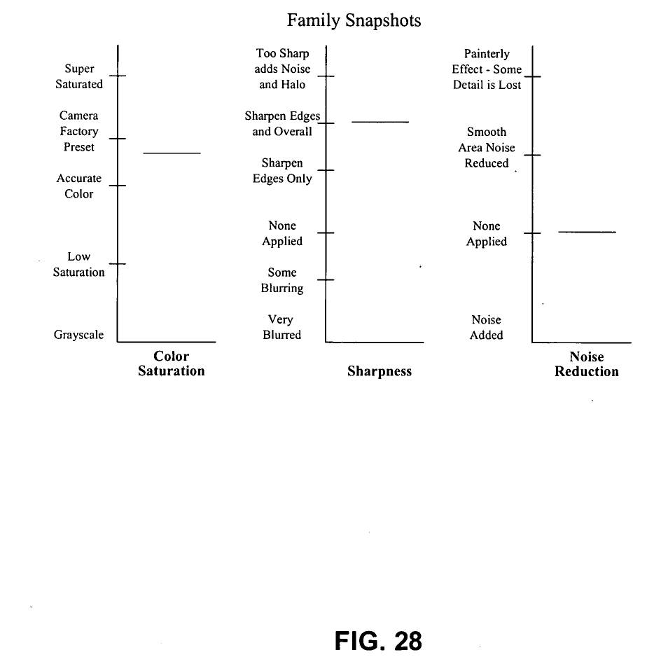

FIG. 28 describes a bundle of processes of color saturation, sharpness and noise reduction that may be typically applied to an image specified as a family snapshot. This processing also includes a pause during the process for user input to determine the amount of highlight detail, shadow detail, and mid tone brightness. All other adjustments run automatically. The color process depicted is the same as that described in FIG. 24, which is a slight decrease in color saturation. The sharpness process is the same as described in FIG. 3, which is a process to improve image sharpness especially on edges and slightly overall. The noise reduction process applied is the same as the process described in FIG. 5, which is a very slight reduction in digital image noise.

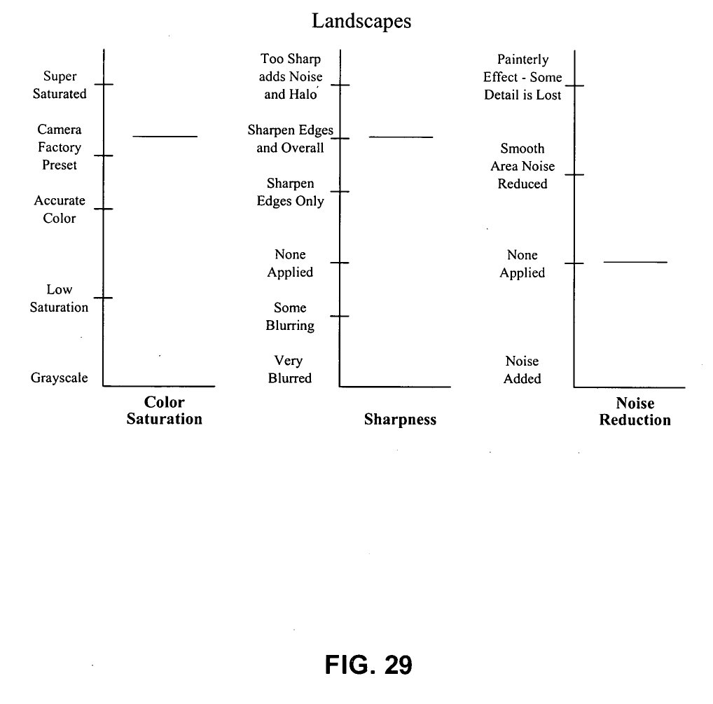

FIG. 29 further describes the choices of processes of color saturation, sharpness and noise reduction that the system applies to an image specified as being of the “landscape.” “Landscape” processing also includes a pause during the process for user input to determine the amount of highlight detail, shadow detail, and mid tone brightness. All other adjustments run automatically. The color process is the same as described in FIG. 14, which is a slight increase in color saturation. The sharpness process is the same as described in FIG. 3 of which improves image sharpness especially on edges and slightly overall. The noise reduction process applied is the same as the process described in FIG. 5, which provides a very slight reduction in digital image noise.

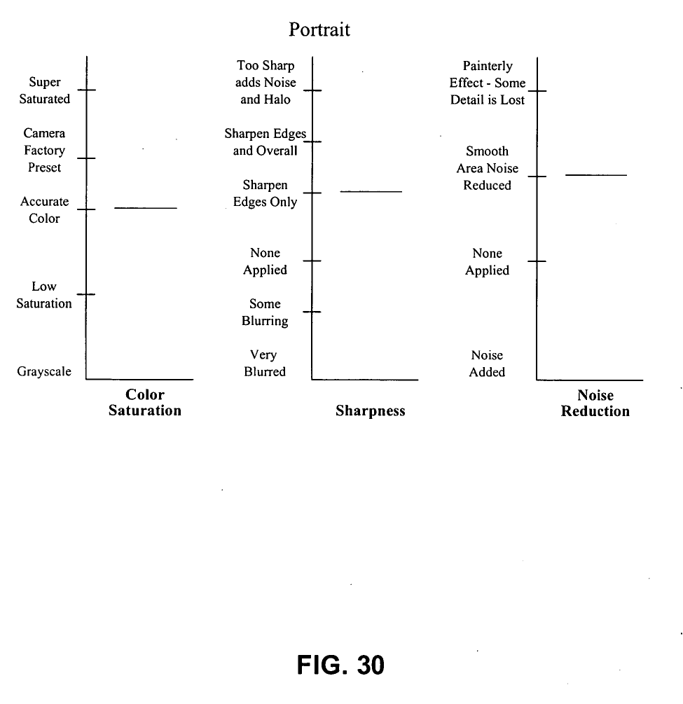

FIG. 30 further describes the choices of processes of color saturation, sharpness and noise reduction that the system applies to an image specified as a being of the portrait genre. “Portrait” processing also may include a pause during the process for user input to determine the amount of highlight detail, shadow detail, and mid tone brightness. All other adjustments run automatically. The Color process is the same as described in FIG. 16, which is a slight decrease in color saturation. The sharpness process is the same as described in FIG. 2 of which improves image sharpness on edges only. The noise reduction process applied is the same as the process described in FIG. 7, which provides a moderate reduction in digital image noise.

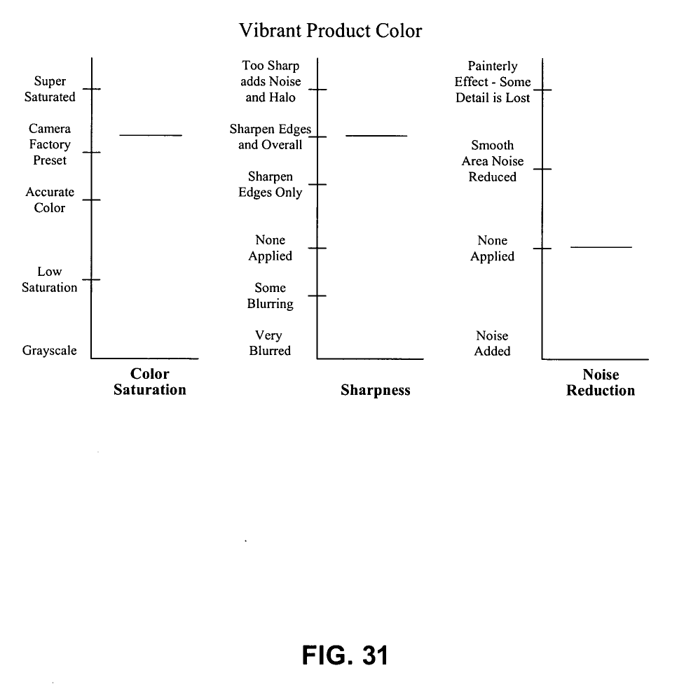

FIG. 31 further describes the choices of processes of color saturation, sharpness and noise reduction that the system applies to an image specified as having vibrant product color. Vibrant product color processing also includes a pause during the process for user input to determine the amount of highlight detail, shadow detail, and mid tone brightness. All other adjustments run automatically. The color process is the same as described in FIG. 18, which provides a large increase in color saturation. The sharpness process is the same as described in FIG. 3, which is a process to improve image sharpness on edges and slightly overall. The noise reduction process applied is the same as the process described in FIG. 5, which is a very slight reduction in digital image noise.

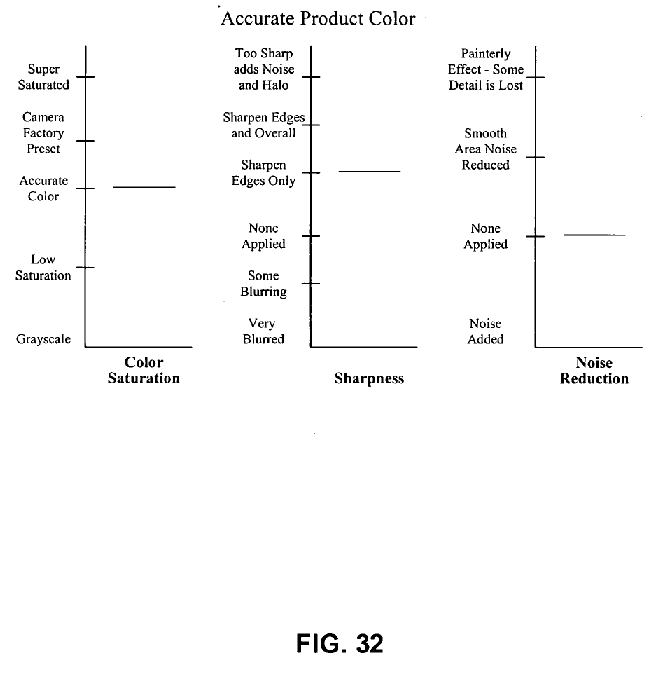

FIG. 32 further describes the choices of processes of Color Saturation, Sharpness and Noise Reduction that the system applies to an image specified as an Accurate Product Color. The “Pro” level for accurate product color processing also includes a pause during the process for user input to determine the amount of highlight detail, shadow detail, and mid tone brightness. All other adjustments run automatically. The color process is the same as described in FIG. 17, which is a slight decrease in color saturation. The sharpness process is the same as described in FIG. 2, which is a process to improve image sharpness on edges only. The noise reduction process applied is the same as the process described in FIG. 5, which is a very slight reduction in digital image noise.

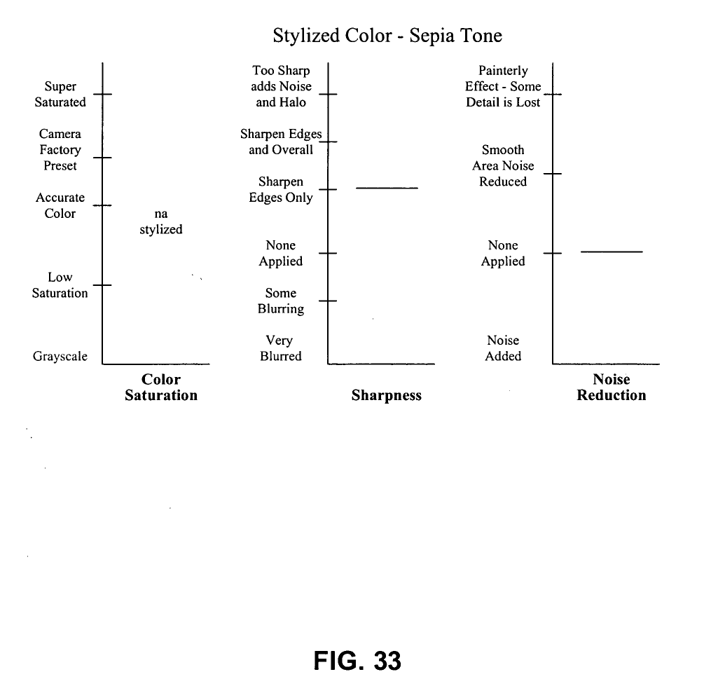

FIG. 33 further describes the choices of processes of color saturation, sharpness and noise reduction that the system applies to an image specified as a stylized color-sepia tone. The “Pro” level for stylized color-sepia tone processing also includes a pause during the process for user input to determine the amount of highlight detail, shadow detail, and mid tone brightness. All other adjustments run automatically. The color process is the same as described in FIG. 21 which is a complete decrease in color saturation to gray scale then the application of a yellow-brown color that has only a slight effect on the luminosity of the image. The sharpness process is the same as described in FIG. 2, which is a process to improve image sharpness on edges only. The noise reduction process applied is the same as the process described in FIG. 5, which is a very slight reduction in digital image noise.

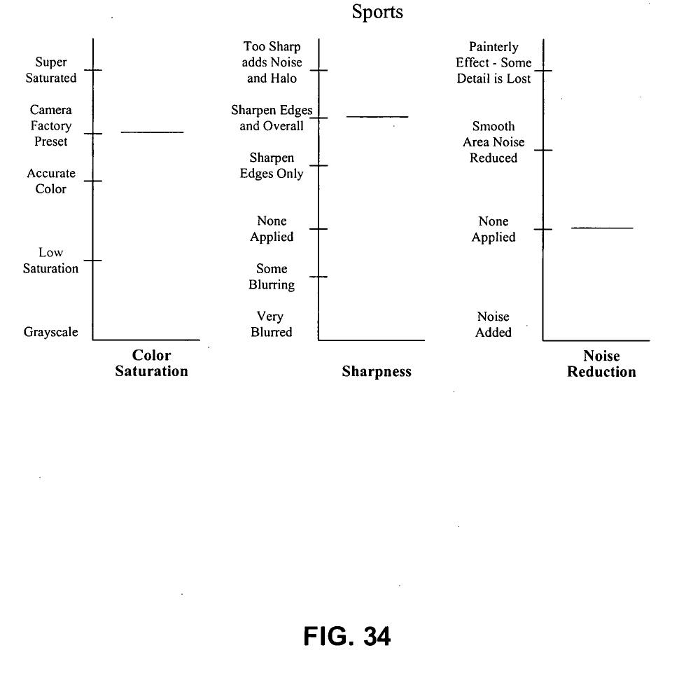

FIG. 34 further describes the choices of processes of color saturation, sharpness and noise reduction that the system applies to an image specified as a sports image. Sport processing also includes a pause during the process for user input to determine the amount of highlight detail, shadow detail, and mid tone brightness. All other adjustments run automatically. The color process is the same as described in FIG. 17, which is a slight increase in color saturation. The sharpness process is the same as described in FIG. 4, which is a process to improve image sharpness especially on edges and slightly overall. The noise reduction process applied is the same as the process described in FIG. 5, which is a very slight reduction in digital image noise.

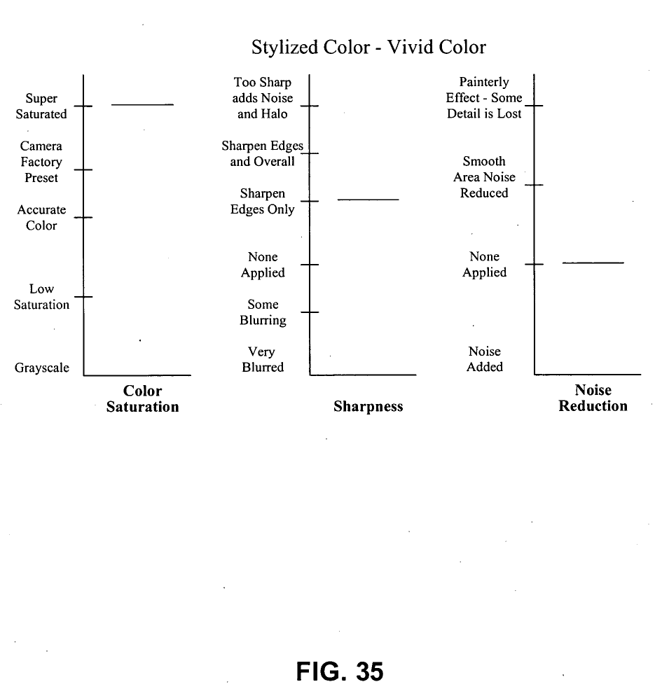

FIG. 35 further describes the choices of processes of color saturation, sharpness and noise reduction that the system applies to an image specified as a stylized color-vivid color. Stylized color-vivid color processing also includes a pause during the process for user input to determine the amount of highlight detail, shadow detail, and mid tone brightness. All other adjustments run automatically. The color process is the same as described in FIG. 22, which is a large increase in color saturation. The sharpness process may be the same as described in FIG. 3, which is a process to improve image sharpness on edges only. The noise reduction process applied may be the same as the process described in FIG. 5, which is a very slight reduction in digital image noise.

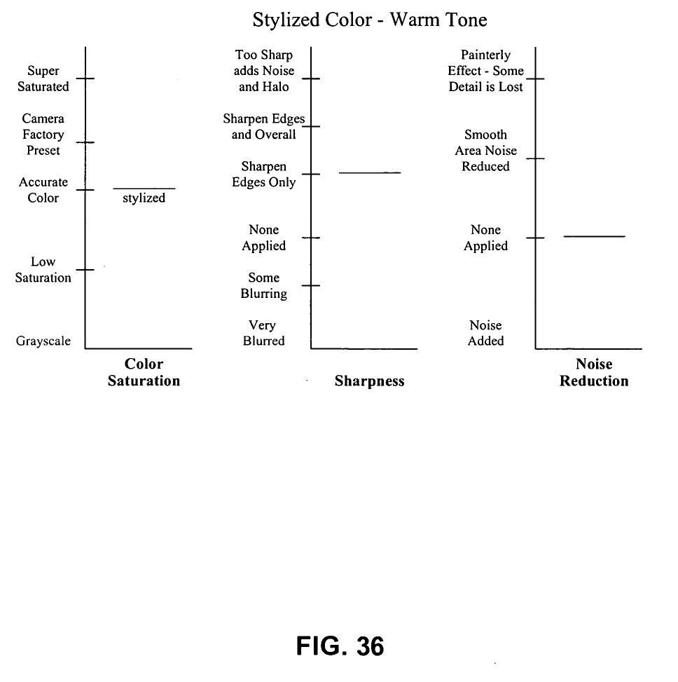

FIG. 36 further describes the choices of processes of color saturation, sharpness and noise reduction that the system applies to an image specified as a stylized color-warm tone. Warm tone processing also includes a pause during the process for user input to determine the amount of highlight detail, shadow detail, and mid tone brightness. All other adjustments run automatically. The Color process may be the same as described in FIG. 23, which is a process to warm the tones of the image. Warming of the image tones means to make the image very slightly more red and yellow and very slightly less blue. The sharpness process may be the same as described in FIG. 2, which is a process to improve image sharpness on edges only. The noise reduction process applied may be the same as the process described in FIG. 5, which is a very slight reduction in digital image noise.

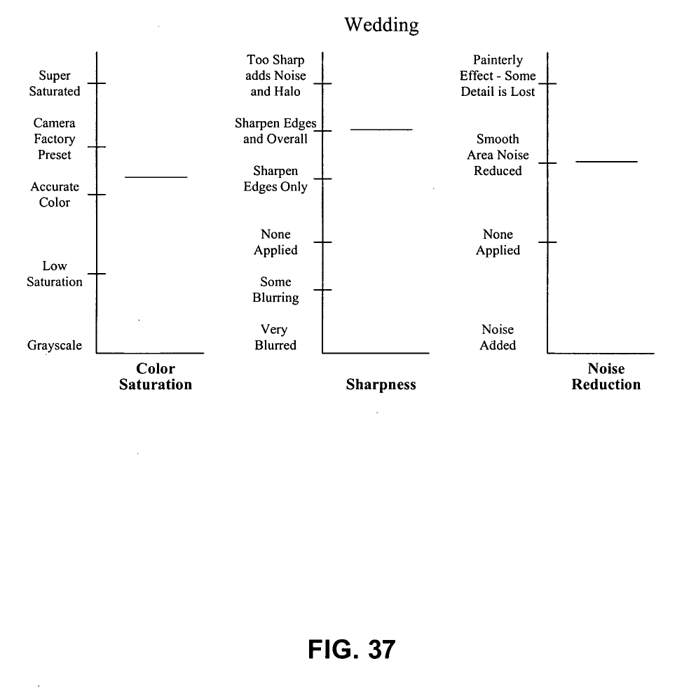

FIG. 37 further describes the choices of processes of color saturation, sharpness and noise reduction that the system applies to an image specified as a wedding. Wedding processing also includes a pause during the process for user input to determine the amount of highlight detail, shadow detail, and mid tone brightness. All other adjustments run automatically. The color process may be the same as described in FIG. 24, which is a slight decrease in color saturation. The Sharpness process may be the same as described in FIG. 3, which is a process to improve image sharpness on especially on edges and slightly overall. The noise reduction process applied may be the same as the process described in FIG. 7, which is a moderate reduction in digital image noise.

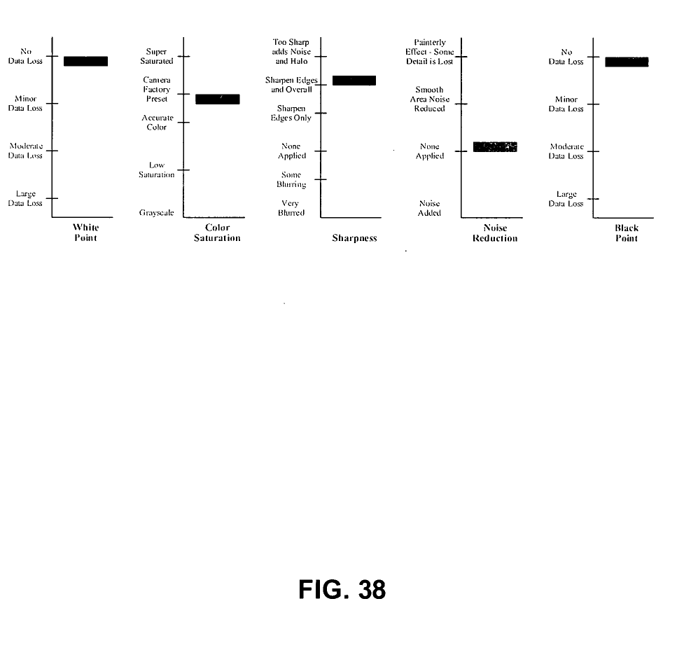

FIGS. 38 through 49 are graphs that represent what the various processes that operate on a digital image in accordance with the present invention.

When the Backlight action of FIG. 38 is applied to photographs it decreases color saturation very slightly while increasing sharpness on “edges” and overall. No noise reduction is applied. Less than 1/10^{th} of a percent of highlight and shadow data are lost. White point and black point are reset to expand tone range (if they were originally set incorrectly). This helps produce a photo with generally better contrast, better skin tones, and improved sharpness. In addition mid and ¾ tones are lightened to reveal more data in the shadowed areas caused by backlighting.

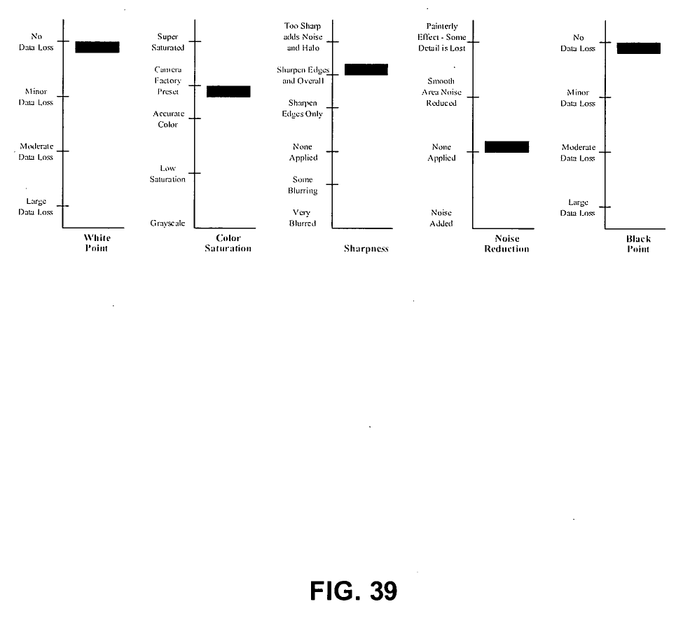

When the Family Snapshot action of FIG. 39 is applied to photographs it decreases color saturation very slightly while increasing sharpness on “edges” and overall. No noise reduction is applied. Less than 1/10^{th} of a percent of highlight and shadow data are lost. White point and black point are reset to expand tone range (if they were originally set incorrectly). This helps produce a photo with generally better contrast, better skin tones, and improved sharpness.

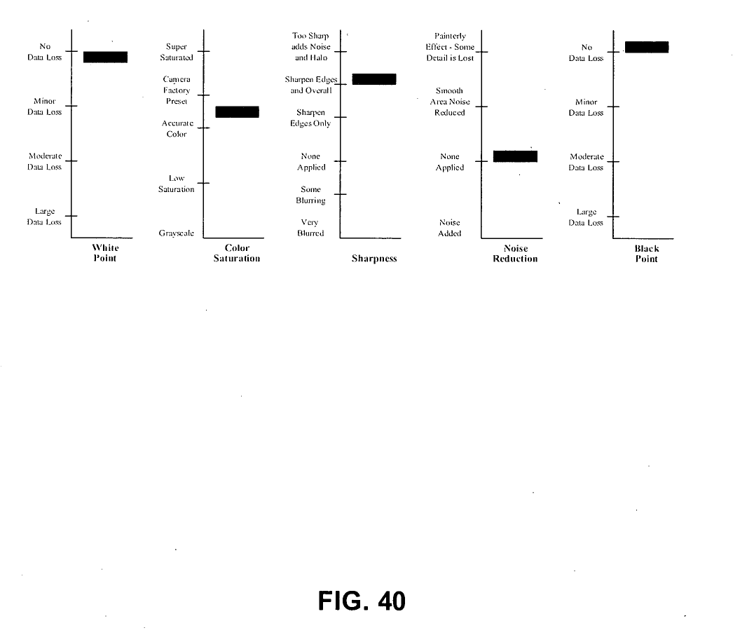

When the Landscape action of FIG. 40 is applied to photographs it enhances color saturation while increasing sharpness on “edges” and overall. No noise reduction is applied. No data is lost in Shadow areas and less than 1/10^{th} of a percent is lost in highlight areas. White point and black point are reset to expand tone range (if they were originally set incorrectly). This helps produce a more vibrant photograph. This Action set is also effective when photographing architecture, seascapes, and other images where sharpness of image and accuracy of color are important.

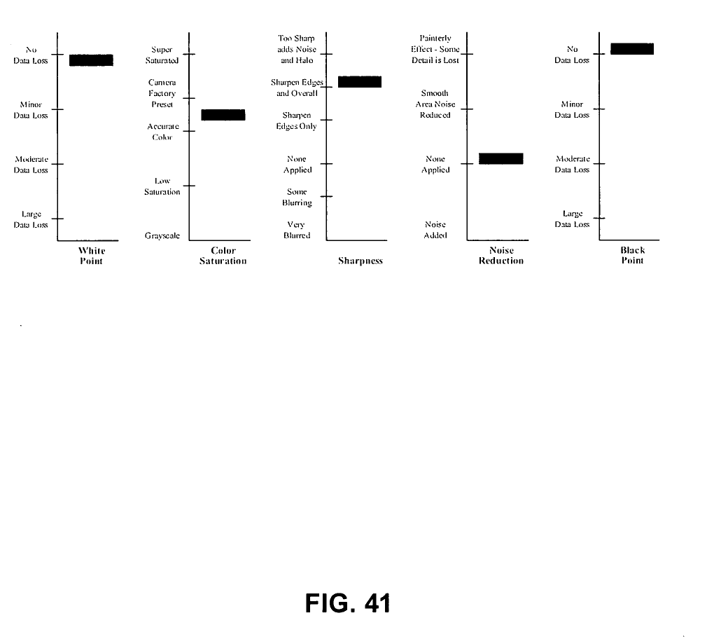

The Dramatic Sky action of FIG. 41 does the same things as the Landscape action set and additionally creates more contrast and drama in the top ⅓ to ½ of the photo. The action enhances color saturation while increasing sharpness on “edges” and overall in the image. No noise reduction is applied. No data is lost in Shadow areas and less than 1/10^{th} of a percent is lost in highlight areas. White point and black point are reset to expand tone range (if they were originally set incorrectly). This helps produce a more vibrant photograph. This Action set is also effective when photographing seascapes, and other images where sharpness of image and accuracy of color are important.

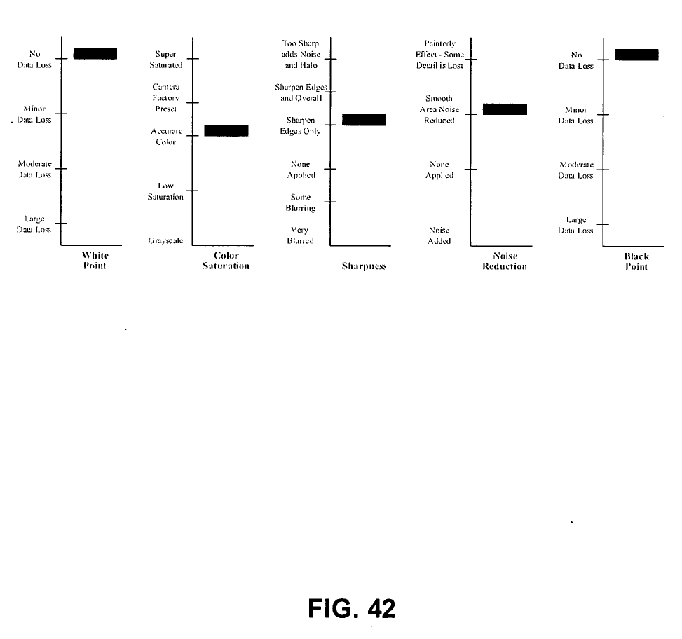

When the Portrait action of FIG. 42 is applied to photographs it decreases color saturation a good bit while increasing sharpness on “edges” only. Smooth area noise reduction is applied in order to help smooth skin areas. No highlight or shadow data is lost. White point and black point are reset to expand tone range (if they were originally set incorrectly). This helps produce a photo with generally better contrast, better skin tones, better skin appearance and improved sharpness especially in the eyes, mouth and hair.

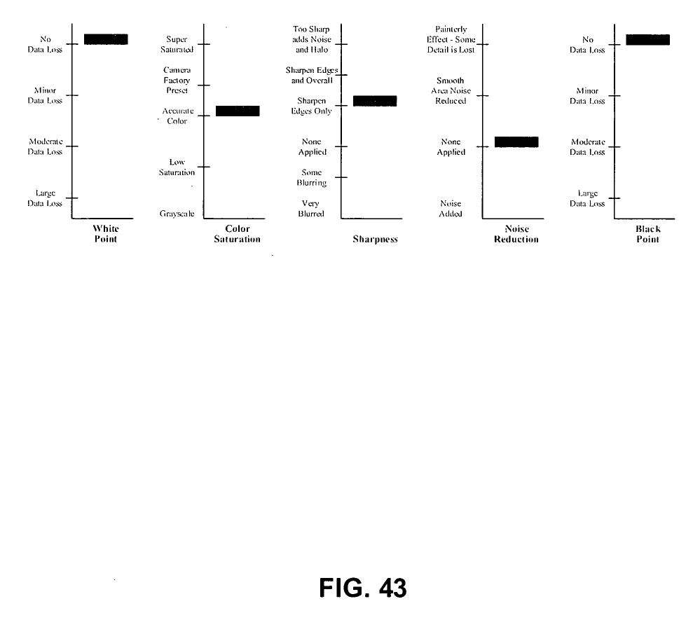

When the Product Accurate Color action of FIG. 43 is applied to photographs it decreases color saturation about 10% while increasing sharpness on “edges” and overall only very slightly. No noise reduction is applied. No highlight or shadow data is lost. White point and black point are reset to expand tone range (if they were originally set incorrectly). This helps produce a photo with generally better contrast, more accurate color (if your digital camera saturates color too much as most do), and improved sharpness.

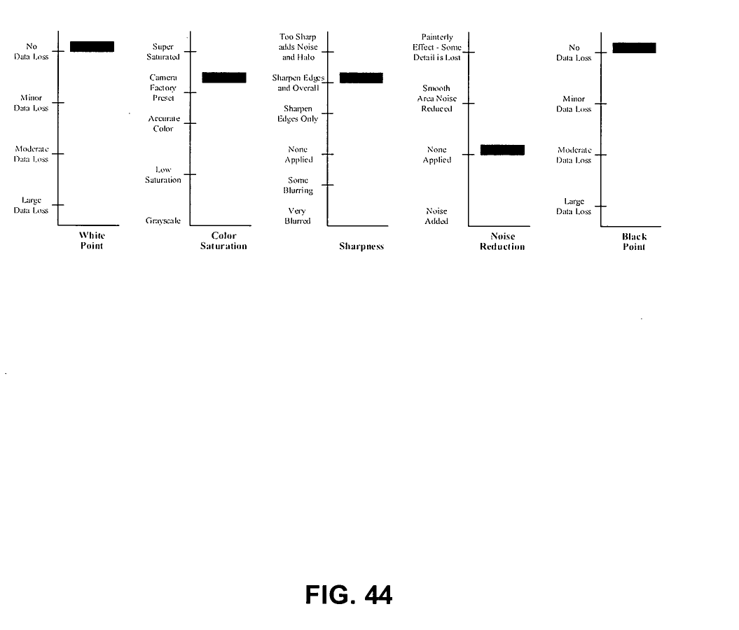

When the Product Vibrant Color action of FIG. 44 is applied to photographs it increases color saturation about 10% while increasing sharpness on “edges” and overall. No noise reduction is applied. No highlight or shadow data is lost. White point and black point are reset to expand tone range (if they were originally set incorrectly). This helps produce a photo with generally better contrast, more vibrant color and improved sharpness.

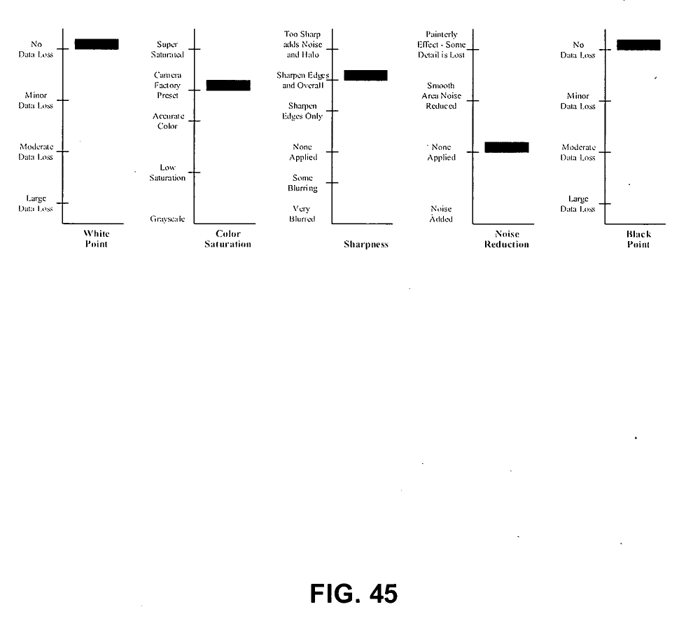

When the Sports action of FIG. 45 is applied to photographs it maintains camera factory preset for color saturation while increasing sharpness on “edges” and overall. No noise reduction is applied. No highlight or shadow data is lost. White point and black point are reset to expand tone range (if they were originally set incorrectly). This helps produce a photo with generally better contrast, pleasing color and much improved sharpness.

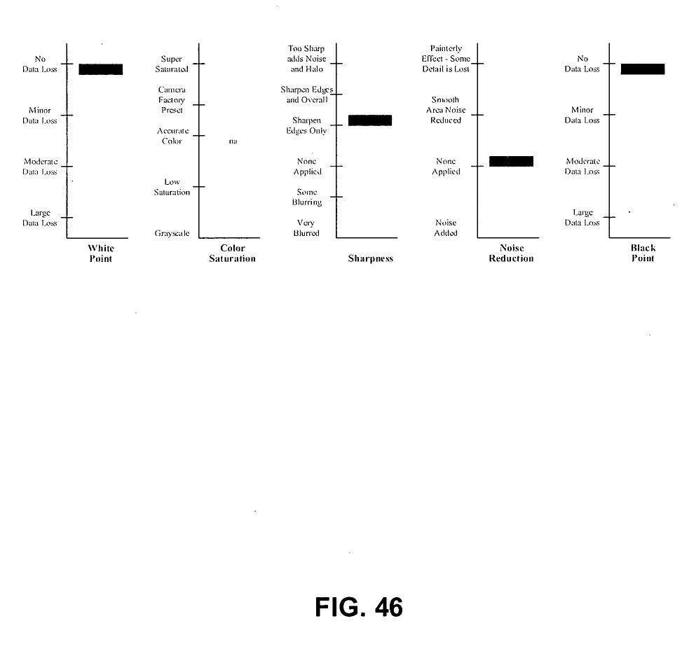

When the Stylized Color-Sepia Tone action of FIG. 46 is applied to photographs it changes the overall color cast to look like a warm or brown tinted black and white photo. There is also an increase in sharpness on “edges” only. No noise reduction is applied. Less than 1/10^{th} of a percent of highlight and shadow data are lost. White point and black point are reset to expand tone range (if they were originally set incorrectly). This helps produce a photo with improved sharpness and the look of an old-time photograph.

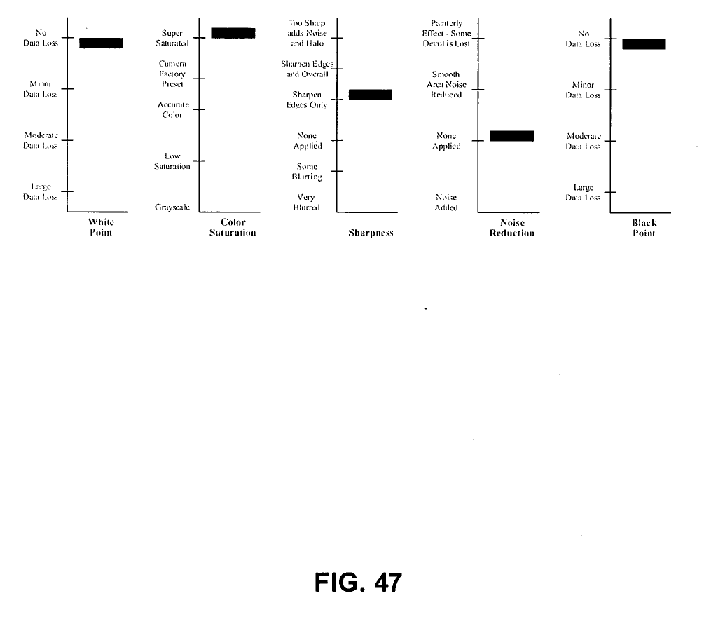

When the Stylize Color-Vivid action of FIG. 47 is applied to photographs it increases color saturation about 30% while increasing sharpness on “edges” and overall. No noise reduction is applied. Less than 1/10^{th} of a percent of highlight and shadow data are lost. White point and black point are reset to expand tone range (if they were originally set incorrectly) This helps produce a photo with generally better contrast, much, much more vibrant color and improved sharpness.

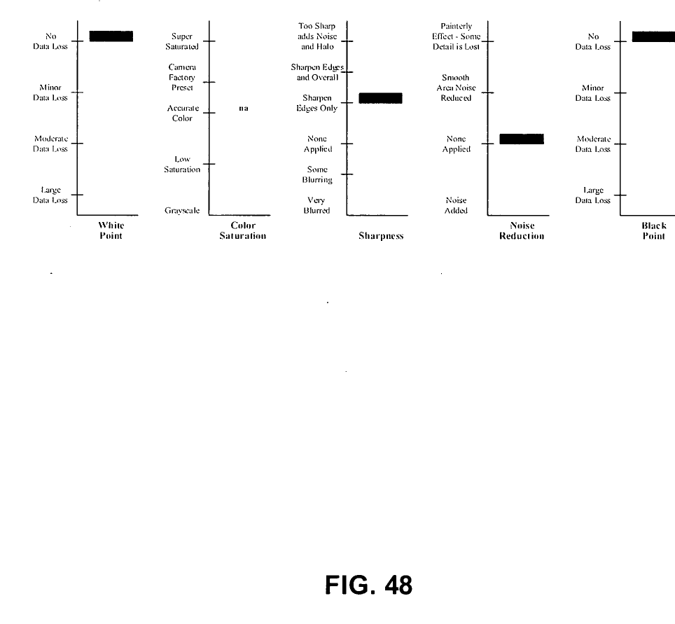

When the Stylized Color-Warm Tone action of FIG. 48 is applied to photographs it doesn't change color saturation but does change the color to a warmer tone. The action also increases sharpness on “edges” and overall. No noise reduction is applied. No highlight or shadow data is lost. White point and black point are reset to expand tone range (if they were originally set incorrectly). This helps produce a photo with generally better contrast, warmer color and improved sharpness.

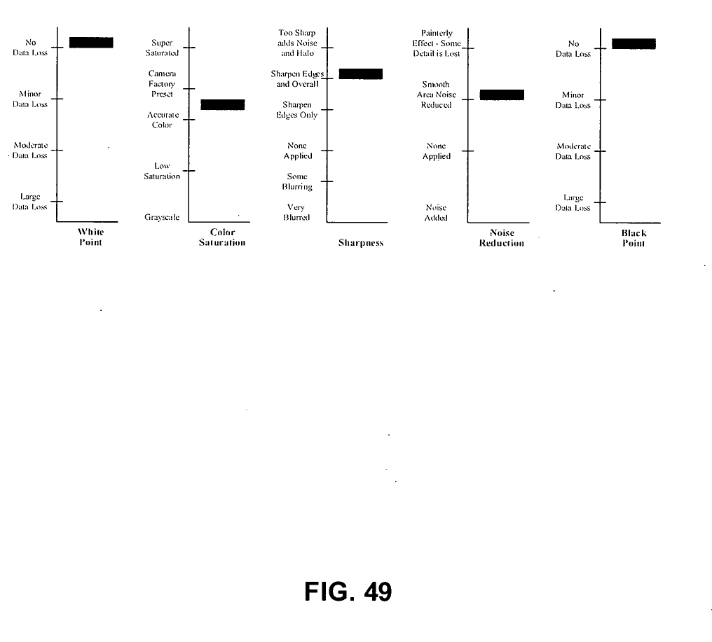

When the Wedding action of FIG. 49 is applied to photographs it decreases color saturation a little bit while increasing sharpness on “edges” and overall. Smooth area noise reduction is applied in order to help smooth skin areas. No highlight or shadow data is lost. White point and black point are reset to expand tone range (if they were originally set incorrectly). This helps produce a photo with generally better contrast, better skin tones, better skin appearance and improved sharpness especially in the eyes, mouth and hair.

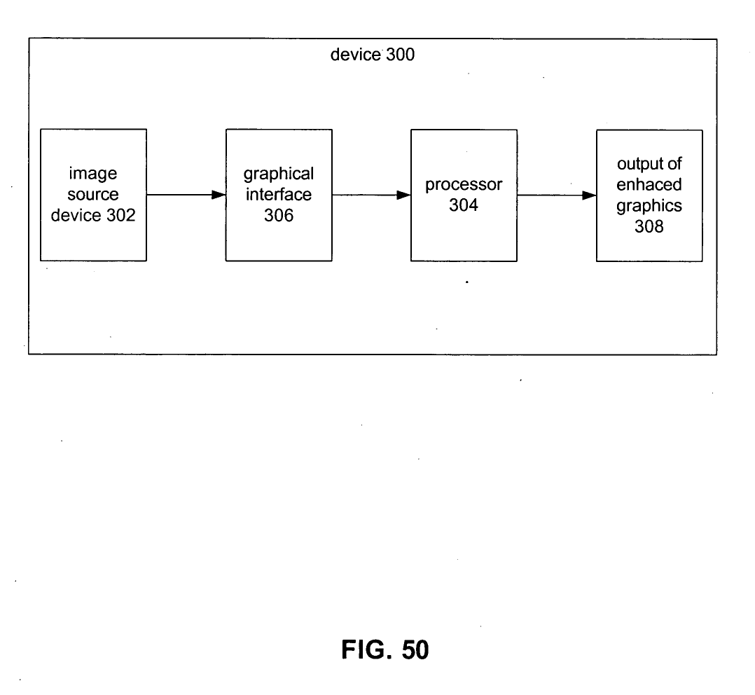

FIG. 50 depicts generically a system which may be used to employ the above described processed. Here a device 302 is used to acquire a digital image. Device 302 may be a camera, a video camera, a picture kiosk, a portable memory device containing a digital picture, a flatbed scanner, a network connection that provides digital files associated with the digital image, a copier, and a video capable wireless terminal. Device 302 will supply the digital image for processing to a processing module 304 through a graphical interface 306. The device graphical interface and processor may be contained within the same device. For example in the case of a digital camera a CCD may be used to capture the digital image. Then the image may be provided via the graphical interface to an internal processor which is used to produce a graphical output 308 of the processed digital image.

The system depicted in FIG. 50 provides enhanced digital images. The graphics interface is operable to receive a digital image. In turn, the processing module is operable coupled to the graphics interface and is operable to determine an image genre associated with the digital image. Then the processing module can select and apply enhancement processes for the digital image based on the image genre associated with the digital image. The processing module may further be operable to determine the image genre from data contained within the digital image, by analyzing the digital image's composition, or from data encoded in the digital image by the device used to acquire the digital image.

The processing module may execute any one of a number of enhancement that sharpen the digital image, reduce noise within the digital image, adjusting a tone range of the digital image, set a white point of the digital image, set a black point of the digital image, and adjust the color of the digital image. These enhancement processes differ depending on the image genre of the digital image. Such image genre of the digital image may include landscapes, portraits, wedding pictures, family pictures, product photographs that would benefit from vibrant color, product photographs that would benefit from accurate color, product photographs that would benefit from a sepia appearance, sports or action photographs, photographs that would benefit from bright and vivid color, and photographs that would benefit from a warmer look.

The processing module provides enhanced digital images to a graphical output device operable to present the enhanced digital image. Such graphical output devices may include of a photo quality printer, a monitor, an image center, copier, plate maker, standard printer, flat bed scanner, digital press, or image projector. In the case of a monitor or other video capable device, each frame of an audio/visual presentation presented on the graphical output device may be an enhanced digital image. In fact, the audio/visual presentation comprises a live television broadcast, video presentation or motion picture.

Processing module 304 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processing module 32 implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. The memory stores, and the processing module executes, operational instructions corresponding to at least some of the steps and/or functions illustrated in FIGS. 1 through 37.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

1-28. (canceled)

29. A system for enhancing digital images, the system comprising:
a digital image acquisition device;
operatively coupled to the digital image acquisition device, a processing module that automatically processes a digital image with one or more sets of image processing actions selected from a plurality of sets of image processing actions, each selected one of the plurality of sets of image processing actions adjusting at least three image characteristics selected from a group of image characteristics comprising sharpness, noise, white point, black point, tone, and color saturation and differing from any other set of image processing actions of the plurality of sets of image processing actions in the degree to which it adjusts at least one of the at least three image characteristics selected from the group of image characteristics;
each set of image processing actions of the plurality of sets of image processing actions being associated with at least one of a plurality of genre types so that after an image is acquired by the image acquisition device and identified as being a selected one of the plurality of genre types, the processing module applies to the image a selected one of the plurality of sets of image processing actions associated with the selected one of the plurality of genre types.

30. The system of claim 29 in which the image is identified as being a selected one of the plurality of genre types by a user of the system.

31. The system of claim 29 in which each selected one of the plurality of sets of image processing actions differs from any other set of image processing actions in the degree to which it adjusts three of the at least three image characteristics selected from the group of image characteristics.

32. The system of claim 31 in which the image is identified as being a selected one of the plurality of genre types by a user of the system.

33. The system of claim 29 in which each selected one of the plurality of sets of image processing actions differs from any other set of image processing actions in the degree to which it adjusts all of the at least three image characteristics selected from the group of image characteristics.

34. The system of claim 33 in which the image is identified as being a selected one of the plurality of genre types by a user of the system.

35. The system of claim 29 in which the processing module pauses in applying the selected one of the plurality of sets of image processing actions to allow a user input that modifies at least one of the image characteristics selected from the group of image characteristics comprising: sharpness, noise, white point, black point, tone, and color saturation.

36. The system of claim 31 in which the processing module pauses in applying the selected one of the plurality of sets of image processing actions to allow a user input that modifies at least one of the image characteristics selected from the group of image characteristics comprising: sharpness, noise, white point, black point, tone, and color saturation.

37. The system of claim 33 in which the processing module pauses in applying the selected one of the plurality of sets of image processing actions to allow a user input that modifies at least one of the image characteristics selected from the group of image characteristics comprising: sharpness, noise, white point, black point, tone, and color saturation.

38. The system of claim 29 in which, after applying to the image the selected one of the plurality of sets of image processing actions, the processing module applies to the image a second selected one of the plurality of sets of image processing actions.

39. The system of claim 31 in which, after applying to the image the selected one of the plurality of sets of image processing actions, the processing module applies to the image a second selected one of the plurality of sets of image processing actions.

40. The system of claim 33 in which, after applying to the image the selected one of the plurality of sets of image processing actions, the processing module applies to the image a second selected one of the plurality of sets of image processing actions.

41. The system of claim 29 embodied in a digital camera.

42. The system of claim 31 embodied in a digital camera.

43. The system of claim 33 embodied in a digital camera.

44. The system of claim 29 embodied in a digital movie camera.

45. The system of claim 31 embodied in a digital movie camera.

46. The system of claim 33 embodied in a digital movie camera.

47. A system for enhancing digital images, the system comprising:
a digital image acquisition device;
operatively coupled to the digital image acquisition device, a processing module that automatically processes a digital image with one or more sets of image processing actions selected from a plurality of sets of image processing actions, each selected one of the plurality of sets of image processing actions for adjusting at least image sharpness, image noise, image tone, and image color saturation;
each set of the plurality of sets of image processing actions being associated with at least one of a plurality of genre types so that after an image acquired by the image processing is identified as being a selected one of the plurality of genre types, the processing module appling to the image acquired by the digital image acquisition device, a selected one of the plurality of sets of image processing actions associated with the selected one of the plurality of genre types.

48. The system of claim 47 in which the processing module applies to the image, a second selected one of the plurality of sets of image processing actions.

49. The system of claim 47 embodied in a digital camera.

50. The system of claim 47 embodied in a digital movie camera.
